(19) United States
(12) Patent Application Publication
(10) Pub. No.: US 2025/0072665 A1
(43) Pub. Date: Mar. 6, 2025

(54) STORAGE STRUCTURE FOR FOOD PROCESSING ACCESSORIES

(71) Applicant: BREVILLE PTY LIMITED, Alexandria, NSW (AU)

(72) Inventors: Mark Anthony THOMAS, Alexandria, NSW (AU); Simon Peter MOORE, Alexandria, NSW (AU)

(21) Appl. No.: 18/580,489

(22) PCT Filed: Jul. 19, 2022
(86) PCT No.: PCT/AU2022/050768

§ 371 Date: Jan. 18, 2024

(30) Foreign Application Priority Data
Jul. 19, 2021 (AU) 2021902209

(51) Int. Cl. A47J 43/07

(52) U.S. Cl. CPC A47J 43/0716; A47J 2043/0738

(57) ABSTRACT

A storage structure (400) for a food processing device (10) with a bowl (16) for processing food using different accessories (82, 84, 86, 88), the storage structure (400) comprising:
a base unit (402) configured to fit within the bowl (16), and
engagement formations (474) to retain a plurality of the accessories (82, 84, 86, 88) on the base unit (402) for individual removal from the base unit (402), and replacement into the base unit (402), without first removing or replacing another of the accessories (82, 84, 86, 88).

### FIELD

The present invention broadly relates to food preparation appliances such as food processors. In particular, the invention relates to the storage of various accessories used by food processors.

The invention has been developed primarily for use with a food processor and will be described herein with reference to this application. However, it will be appreciated that the invention is not limited to that particular field of use.

### BACKGROUND

Food processors perform a variety of food preparation operations such as chopping, slicing, dicing and julienning as well as mixing, stirring or liquefying food stuffs within a preparation vessel such as a bowl. The different functions are normally performed by particular accessories mounted in the preparation bowl. A motor driven spindle within the bowl engages a particular accessory associated with a required food processing operation and rotates the accessory at a speed suitable for that processing operation and the food being processed.

Food processors are typically provided with multiple accessories to perform the various food preparation operations discussed above. Such accessories may include grating or shredding disks, adjustable slicers, dicing kits (a grid of blades and/or series of parallel blades beneath a rotating slicing blade), dough blades and chopping blades. When the food processor is not in use, the accessories may be stored in a vessel separate from the food processor. To accommodate multiple accessories, such vessels must be of sufficient size and configuration to safely and efficiently store the various accessories. Conventional storage vessels for food processing accessories tend to be large and bulky thereby occupying a substantial amount of kitchen space. Additionally, the arrangement of conventional storage vessels may not effectively accommodate multiple accessories with exposed cutting blades which can lead to safety concerns for the user when storing or retrieving accessories from the vessel. In some cases, the accessories are stored within the food processor preparation bowl itself if the bowl is volumetrically large enough to accommodate all the various accessories. However, the food processor preparation bowl is purpose built and designed for its food processing function rather than the correct and safe storage of multiple accessories, some with sharp cutting blades.

### SUMMARY OF INVENTION

It is an object of the present invention to substantially overcome, or at least ameliorate, one or more of the disadvantages discussed above, or at least provide useful alternative to the above discussed food processors.

One aspect of this disclosure provides a storage structure for a food processing device with a bowl for processing food using different accessories, the storage structure comprising:
a base unit configured to fit within the bowl, and
engagement formations to retain a plurality of the accessories on the base unit for individual removal from the base unit, and replacement into the base unit, without first removing or replacing another of the accessories.

A second aspect of this disclosure provides a storage structure for food processing device with a bowl for processing food using different accessories, the storage structure comprising:
a base unit configured to fit within the bowl, and,
formations provided on the base unit to detachably retain each of the accessories, the formations configured for individual detachment of each of the accessories without first detaching another of the accessories.

A third aspect of this disclosure provides a storage structure for a food processing device with a bowl for processing food using different accessories, the storage structure comprising:
a base unit configured to fit within the bowl, the base unit having recesses to store the accessories, the recesses being configured for individual removal of each of the accessories without removal of another of the accessories.

A fourth aspect of this disclosure provides a storage structure for a food processing device with a bowl for processing food using different accessories, the storage structure comprising:
a base unit configured to fit within the bowl, the base unit having recesses to store the accessories, the recesses being configured for individual removal of each of the accessories without removal of another of the accessories.

A fifth aspect of this disclosure provides a storage structure for a food processing device with a bowl for processing food using different accessories rotatably driven by a spindle operatively connected to a motorised base via a drive coupling within the bowl, the storage structure comprising:
a base unit configured to fit within the bowl, and the base unit having a cavity to accommodate the drive coupling when in the bowl such that the drive coupling is spaced from contact with any part of the base unit and the accessories retained by the base unit.

A sixth aspect of this disclosure provides a storage structure for a food processing device with a bowl for processing food using different accessories, the storage structure comprising:
a base unit configured to fit within the bowl;
formations provided on the base unit to engage the accessories for individual removal from the storage structure without removal of another of the accessories; and,
a lift portion for manually lifting the storage structure from the bowl without user contact with any of the accessories.

Preferably, the base unit has recesses to store the accessories, each of the recesses having at least one of the engagement formations to detachably engage the accessories such that the accessories are stored within the recesses to prevent direct contact of one of the accessories with another of the accessories.

Preferably, the food processing device has a spindle to engage the accessories for rotation within the bowl, and some of the engagement formations are configured to retain the spindle, such that the spindle is removable from the base unit without requiring removal of any of the accessories stored in the base unit.

Preferably, the base unit has a socket to receive the spindle, the socket having a plurality of the formations for detachably gripping the spindle during storage and allowing manual removal of the spindle by a user.

Preferably, at least one of the recesses is configured for storing a designated one of the accessories only.

Preferably, the storage structure further comprises a removable mount in the at least one recess, the removable mount having the formations to detachably engage the accessory for storage within the recess.

Preferably, the removable mount and the at least one recess have complementary bayonet tabs and apertures forming a bayonet connection between the mount and the recess.

Preferably, the storage structure further comprises a cover for attachment to the base unit, the cover and the base unit defining at least one slot to retain one of the accessories formed as a disk for rotation in the bowl.

Preferably, the hinged connection of the lift handle extends wholly across a diameter of the base unit.

Preferably, the cover and the base unit define a plurality of the slots to individually retain one of the disks respectively.

Preferably, the storage structure further comprises an additional unit for detachable engagement with the cover, the additional unit being configured to hold an additional accessory for the food processing device, such that the additional unit does not prevent removal of any of the plurality of accessories stored in the storage structure.

Preferably, the bowl has a base with a spindle drive coupling, and the storage structure further comprises a drive coupling cavity for accommodating the spindle drive coupling when the base unit is within the bowl such that the spindle drive coupling does not touch any part of the storage structure or the plurality of accessories.

Preferably, the storage structure is configured to be lifted out of the bowl without requiring user contact with any of the accessories. Optionally, the cover has a lift handle with hinged connection for rotation to an upright orientation to lift the storage structure from the bowl. In another option, the additional unit has lift tabs for lifting the storage structure from the bowl.

Preferably, the plurality of accessories includes one or more of:
a. a chopping blade;
b. a dough blade;
c. an adjustable slicing disk; and
d. an adjustable shredding disk.

Preferably, the additional accessory is a dicing kit.

Preferably, the food processing device has a lid for the bowl wherein the storage structure is configured to fit in the bowl with the lid on the bowl.

Preferably, the food processing device has a lid for the bowl wherein the additional unit is configured to receive the lid to cover the additional accessory.

A seventh aspect of this disclosure provides a storage structure for a food processing device with a bowl for processing food using different accessories, the storage structure comprising:
a body which stores at least one accessory, wherein the body is configured to fit within the bowl.

Preferably the body houses/encloses the at least one accessory.

Preferably the body comprises a lift portion for manually lifting the storage structure from the bowl without user contact with any of the accessories.

Preferably the body defines at least one formation shaped to correspond with a peripheral profile of the at least one accessory to provide a visual indication of a correct storage location for the at least one accessory.

Preferably, the storage structure further comprises an additional unit for detachable engagement with the cover, the additional unit being configured to hold an additional accessory for the food processing device,
wherein the cover includes a channel; and
wherein the additional unit includes a first protrusion that is slidingly releasably engageable with the channel to retain the additional unit against the cover.

Preferably, the cover includes a second protrusion that is releasably engageable with a wall recess in the base unit to retain the cover against the base unit.

Preferably, the cover includes a ramp leading over a wall to a first recess, and wherein the additional unit includes a tongue with a third protrusion, the third protrusion being adapted to engage the ramp and slide over the wall to engage the first recess to prevent movement of the additional unit relative to the base unit when the first protrusion has slidingly engaged the channel.

Preferably, the tongue includes a through hole to allow lifting of the tongue using an angled tool.

Preferably, the additional unit includes a backstop to engage the base unit when the first protrusion has fully engaged the channel to prevent disengagement of the first protrusion from the channel.

Preferably, the additional unit includes a hook to engage a second recess in a sidewall of the base unit to prevent rotation of the additional unit relative to the base unit.

An eighth aspect of this disclosure provides a storage structure for a food processing device with a bowl for processing food using different accessories, the storage structure comprising:
a body which stores a plurality of accessories, wherein a plurality of accessories comprises a first and a second accessory;
at least one formation to allow the first accessory nests and/or stacks on the second accessory.

A ninth aspect of this disclosure provides a storage structure for a food processing device with a bowl for processing food using different accessories, the storage structure comprising:
a body which stores at least one accessory, wherein the body is configured to fit within the bowl;
at least one formation to provide access for the user to remove the at least one accessory from and/or replace the at least one accessory into the body.

A tenth aspect of this disclosure provides a storage structure for a food processing device with a bowl for processing food using different accessories, the storage structure comprising:
a body which stores a plurality of accessories, wherein a plurality of accessories comprises a first and a second accessory, wherein the first accessory comprises an engagement feature to securely retain the second accessory within the body.

### BRIEF DESCRIPTION OF DRAWINGS

Preferred embodiments of the present invention will now be described by way of example only, with reference to the accompanying drawings in which:

FIG. 1 is a perspective view of a food processor with a storage structure for food processing accessories according to a first embodiment;

FIG. 2 is a perspective view of a food processor with a storage structure according to a second embodiment;

FIG. 3 is an exploded perspective of the food processor and the storage structure according to the first embodiment shown in FIG. 1;

FIG. 4 is an exploded perspective of the food processor and the storage structure according to the second embodiment as shown in FIG. 2;

FIG. 5 is a sectioned view of the storage structure according to a first embodiment;

FIG. 6 is a sectioned view of the storage structure according to the second embodiment;

FIG. 7 is a front, right side perspective of a base unit of the storage structure;

FIG. 8 is a rear, left side perspective of the base unit;

FIG. 9 is a rear, right side perspective of the base unit;

FIG. 10 is a front, left side perspective of the base unit;

FIG. 11 is a front, right side perspective of the storage structure according to the second embodiment with an additional unit in the locked position on the cover attached to the base unit;

FIG. 12 is a rear, left side perspective of the storage structure shown in FIG. 11;

FIG. 13 is a rear, right side perspective of the storage structure shown in FIG. 11;

FIG. 14 is a front, left side perspective of the storage structure shown in FIG. 11;

FIG. 15 is a front, right side perspective of the cover for the base unit;

FIG. 16 is a rear, left side perspective of the cover of FIG. 15;

FIG. 17 is a rear, right side perspective of the cover of FIG. 15;

FIG. 18 is a front, left side perspective of the cover of FIG. 15;

FIG. 19 is an exploded perspective of the storage structure according the first embodiment with the processing accessories spaced from the storage structure in their respective directions of removal/replacement;

FIG. 20 is an exploded perspective of the storage structure according to the second embodiment with the processing accessories spaced from the storage structure in their respective directions of removal/replacement;

FIG. 21 is a front, left side perspective of the storage structure according to the first embodiment with the shredding disk and adjustable slicer disk inserted in the shredding disk slot and the adjustable slicer slot respectively;

FIG. 22 is a front, left side perspective of the storage structure according to the second embodiment with the dicing kit in the additional unit on the base unit;

FIG. 23 is a plan view of the additional unit on the cover of the base unit with the additional unit in the unlocked position;

FIG. 24 is a front, left side perspective of the storage structure according to the second embodiment with the additional unit in the unlocked position on the cover of the base unit;

FIG. 25 is an exploded perspective of the storage structure according to the second embodiment with the spindle socket, chopping blade mount, dough blade mount and lift handle disassembled;

FIG. 26 is an exploded perspective of the base unit with the spindle socket, the chopping blade mount and the dough blade mount disassembled;

FIG. 27 is a left side elevation of the storage structure according to the first embodiment showing the dough blade recess in the base unit;

FIG. 28 is a section view of the storage structure according to the first embodiment without the processing accessories or the spindle socket, chopping blade mount and dough blade mount; and

FIG. 29 is a front left side perspective of the storage structure according to the first embodiment with the lift handle rotated to an upright configuration.

FIG. 30 is an isometric view of a storage structure according to a second embodiment of the invention.

FIG. 31 is an exploded isometric view of the storage structure of FIG. 30.

FIG. 32 is an isometric view of a base unit of the storage structure of FIG. 30.

FIG. 33 is a section view of the storage structure of FIG. 30.

FIG. 34 is an isometric view of a base unit cover of the storage structure of FIG. 30.

FIG. 35 is a top isometric view of an additional unit of the storage structure of FIG. 30.

FIG. 36 is a top isometric view of the additional unit of FIG. 35.

FIG. 37 is a bottom isometric view of the additional unit of FIG. 35.

FIG. 38 is a bottom isometric view of the storage structure of FIG. 30. before full engagement of the additional unit with the base unit.

FIG. 39 is a bottom isometric view of the storage structure of FIG. 30 with the additional unit in full engagement with the base unit.

### DESCRIPTION OF EMBODIMENTS

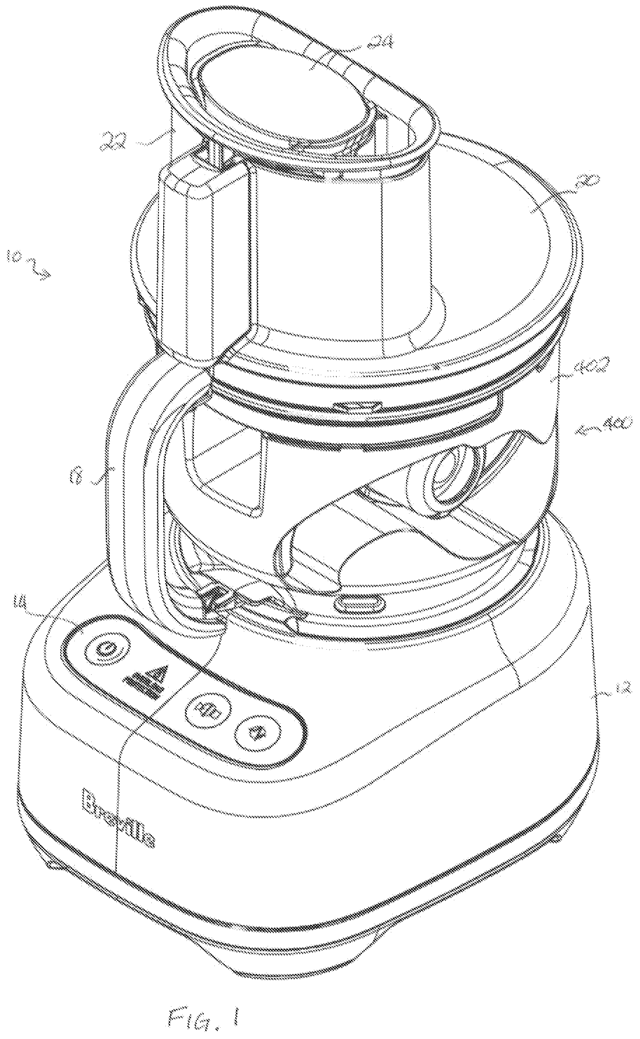

Referring to the Figures, a food processor 10 is shown in FIG. 1 with the processing bowl 16 removed to show a storage structure 400 according to a first embodiment housed therein.

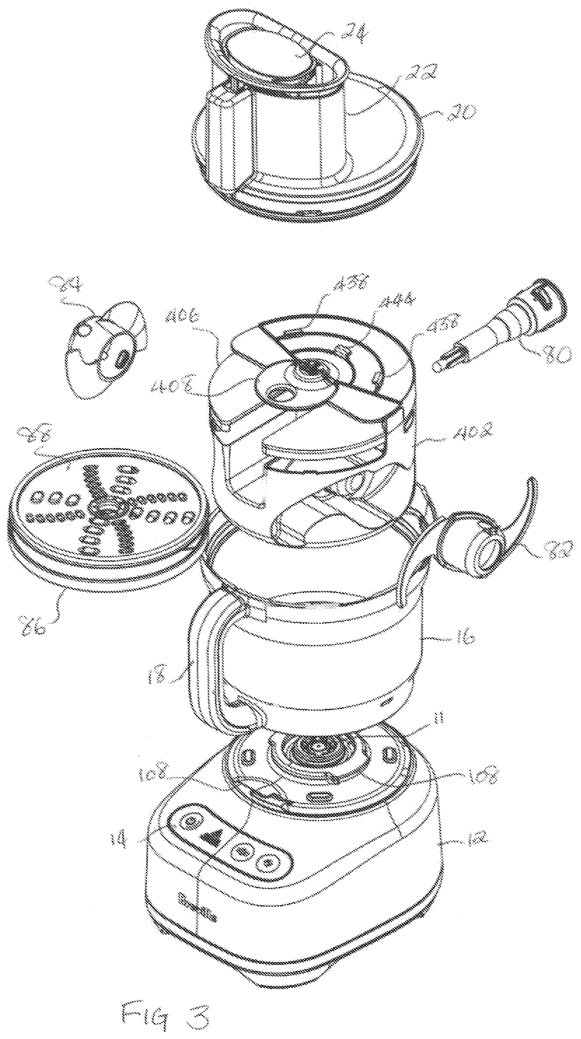

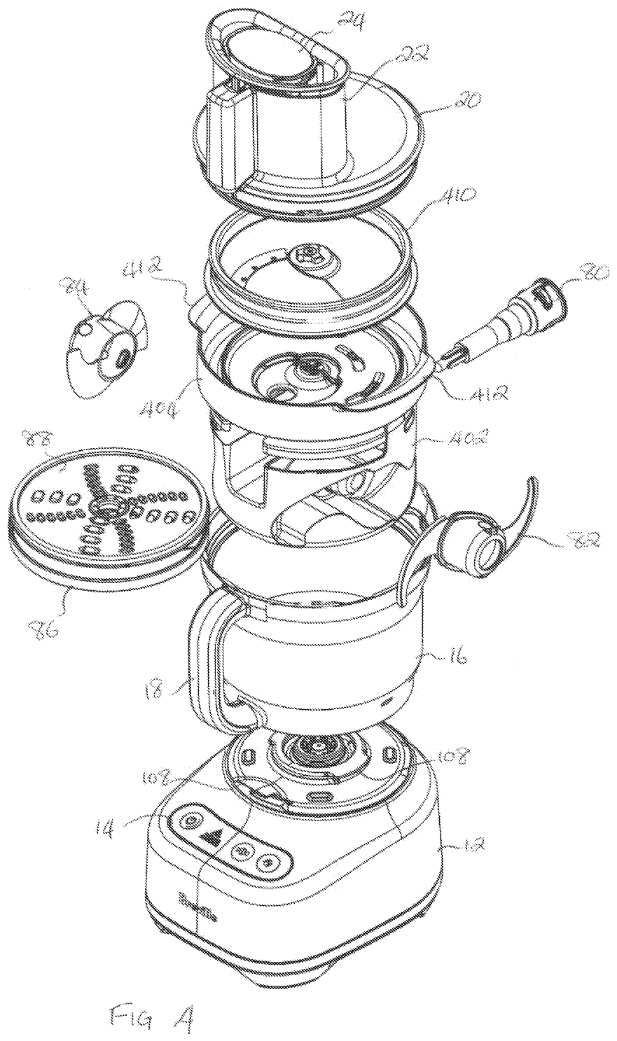

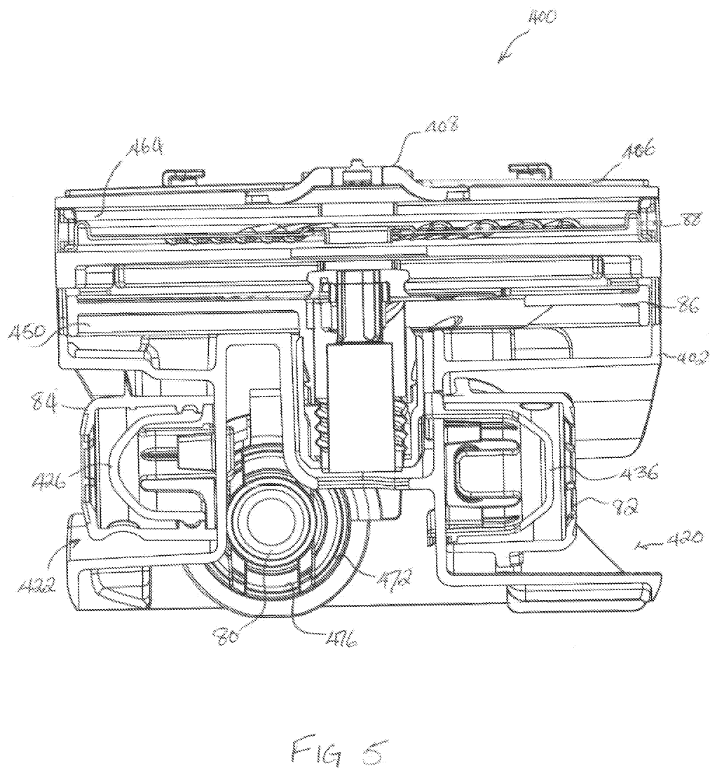

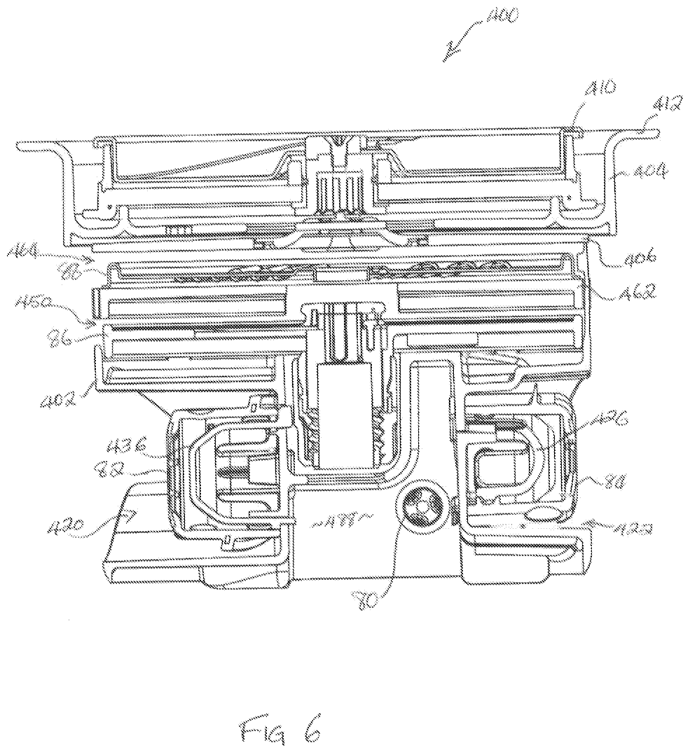

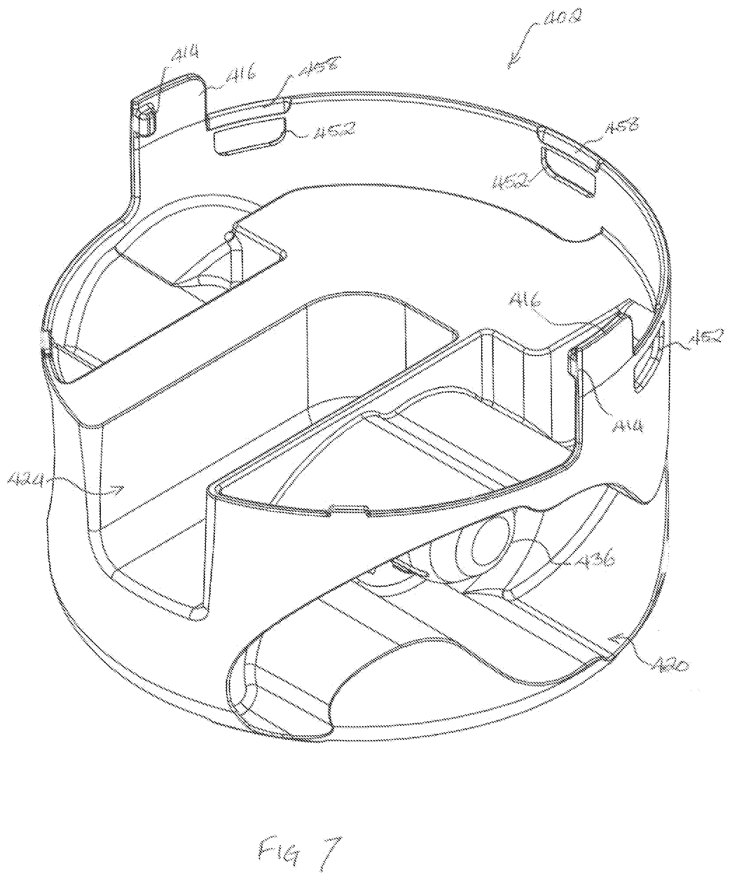

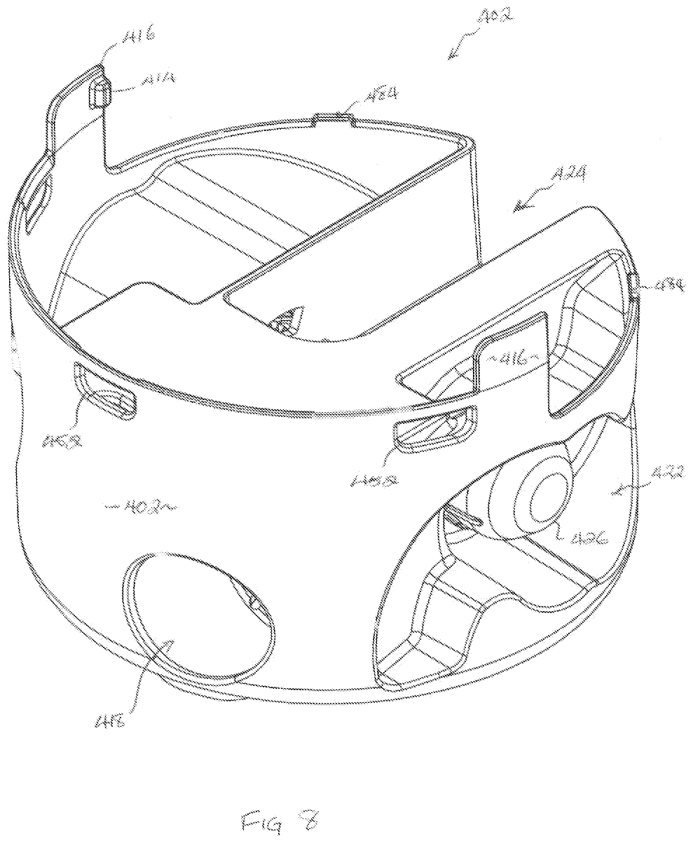

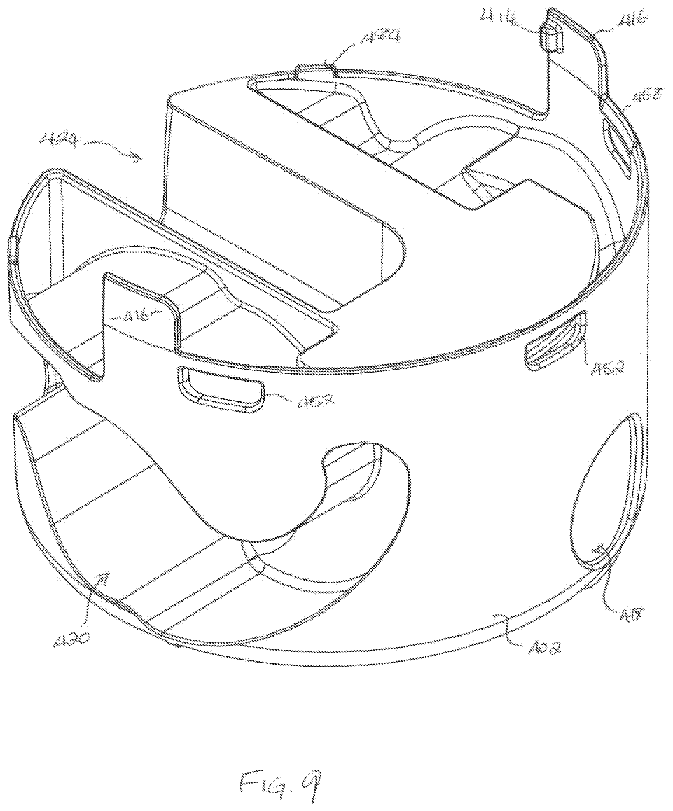

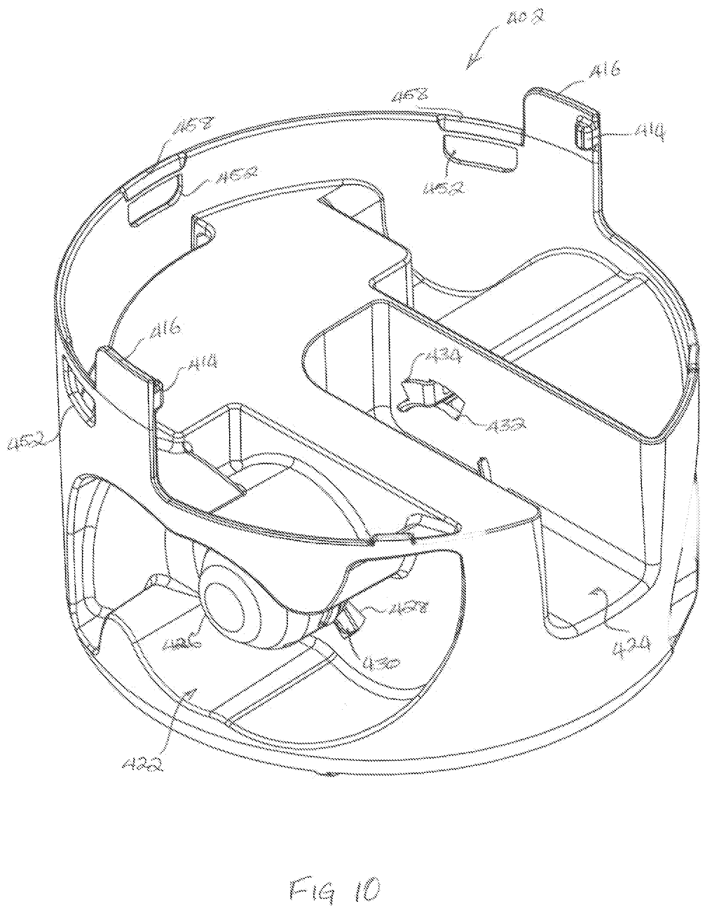

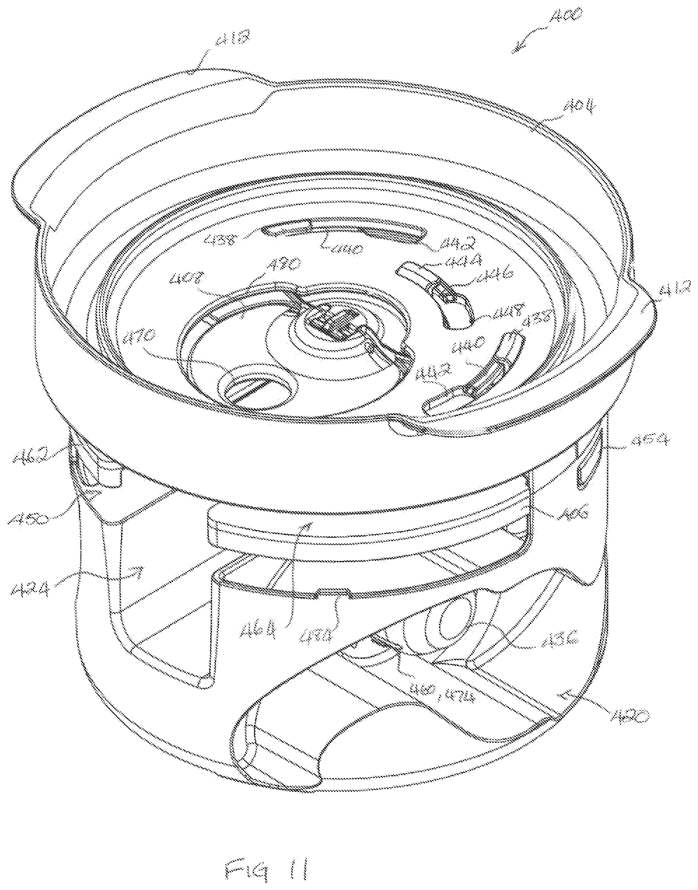

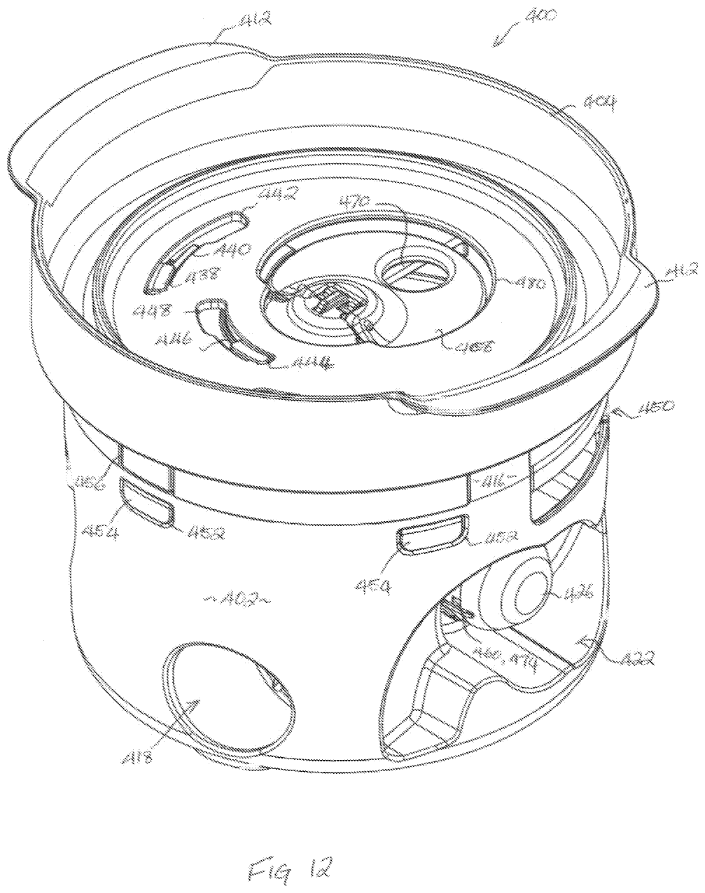

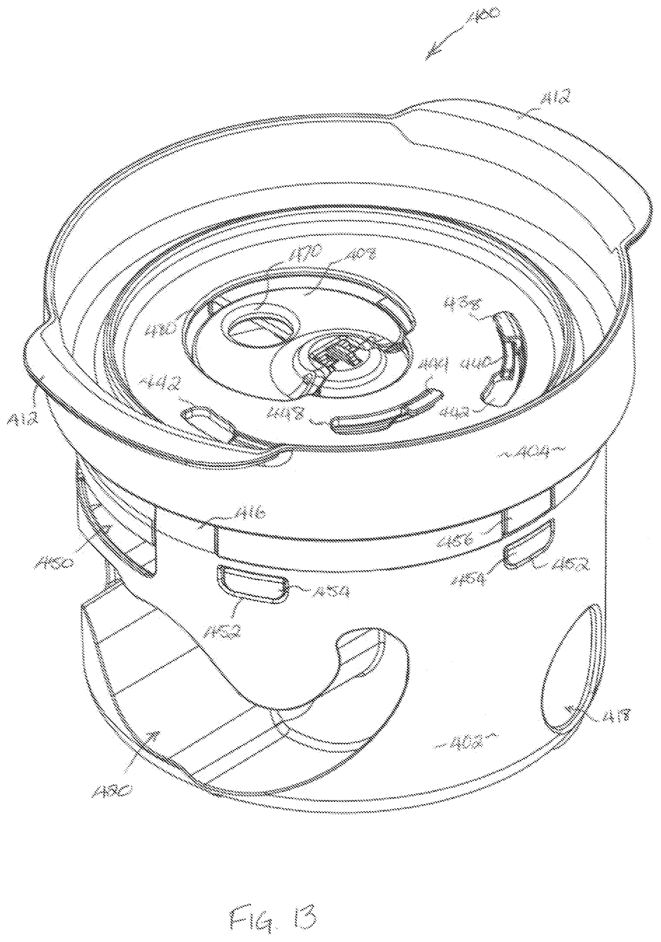

The food processor 10 has a motorised base 12 with a user interface 14 to facilitate control of the device. As best shown in FIG. 3, the food processor 10 includes a processing bowl 16 that detachably secures to the motorised base 12 via a base interlock assembly 108. The base interlock assembly includes complementary features on the top of the motorised base 12 and the bottom of the bowl 16. The user grips the handle 18 to manually rotate the bowl relative to the motorised base 12 to release or engage the base interlock assembly 108.

The top of the bowl 16 is closed with a lid 20 having a feed tube 22 for safely inserting food into the bowl 16. A pusher 24 may be inserted into the feed tube 22 to force the food into the bowl and to discourage the user from manually pushing food through the tube 22 with fingers.

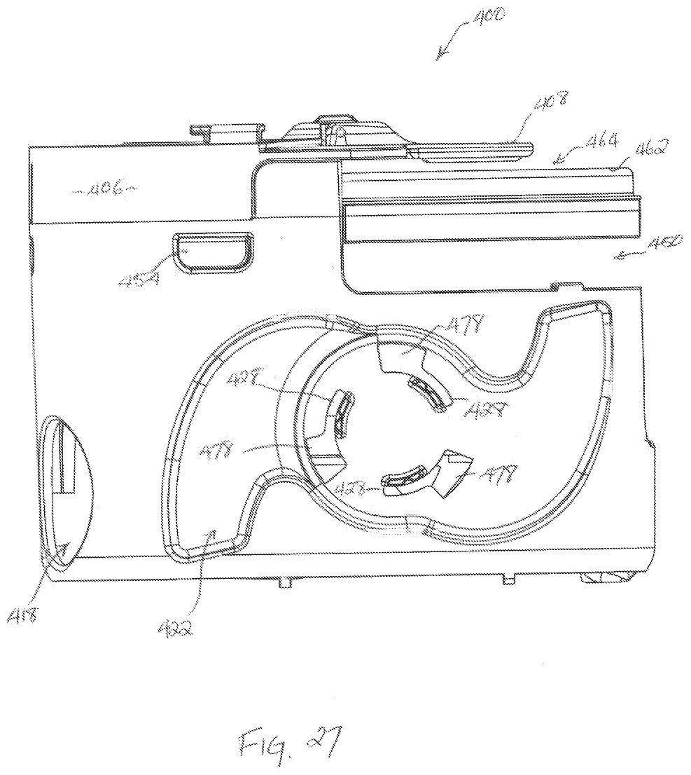

A spindle drive coupling 109 (see FIG. 28) protruding from the base of the bowl 16 engages the drive socket 11 in the top of the motorised base 12. The drive socket 11 mates with lower end of the spindle drive coupling 109 while the upper end within the bowl 16 is configured to detachably engage the spindle 80. The spindle 80 detachably engages the various food processing accessories (e.g. 82, 84, 86 and 88 described below) for rotation within the bowl during the associated food processing operation.

FIGS. 1 and 3 depict a first embodiment of the storage structure 400 which can hold four separate processing accessories (82, 84, 86 and 88) as well as the spindle 80. The storage structure 400 according to the first embodiment can fit completely within the bowl 16 such that the lid 20 can engage the bayonet features of the bowl 16 in the usual manner. This provides storage of the various food processing accessories as well as the spindle 80 in a secure manner with the sharp blade edges prevented from damaging contact with each other or the bowl itself. The storage structure 400 has a base unit 402 moulded from high wear systems material such as Triton® or SAN (Triton® is a BPA free (bisphenol A free) plastic marketed by Eastman Chemical Company of the United States). SAN is the common name for the copolymer plastic, styrene acrylonitrile.

A base unit cover 406 is attached to the top of the base unit 402 such that the storage structure 400 provides slots for the adjustable slicing disk 86 and the shredding disk 88 (described in greater detail below). The cover 406 also includes a hinged lift handle 408 allowing the entire storage structure 400 to be removed from within the bowl 16 without requiring the user to touch any of the stored accessories 82, 84, 86 or 88. This avoids the risk of injury to the user through inadvertent contact with any of the sharp blades used on the processing accessories. Furthermore, as will be discussed in greater detail below, each of the accessories 82, 84, 86 and 88 may be individually removed from the storage structure 400 without first needing to remove any of the other accessories. This also reduces the risk of harmful contact with sharp portions of the accessories as well as potentially unhygienic contact with accessories that are handled merely for the purpose of accessing another accessory within the storage structure 400.

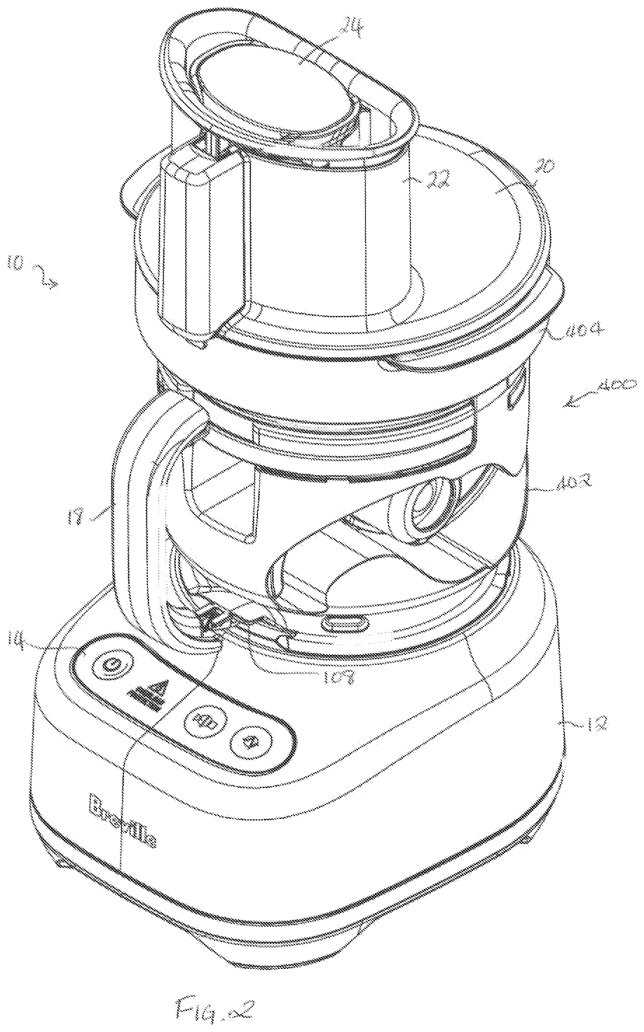

A second embodiment of the storage structure 400 is shown in FIGS. 2 and 4. The second embodiment of the storage structure 400 includes an additional unit 404 that can detachably engage the base unit cover 406 to provide storage for another accessory such as a dicing kit 410. It will be appreciated that this provides options for the user to purchase the food processor 10 with just the more commonly used accessories 82, 84, 86 and 88, or with more specialised accessories such as the dicer kit 410. The additional accessory is securely stored together with the other accessories in a storage structure with the additional unit 404. Furthermore, the additional unit 404 may be a subsequent purchase together with the dicing kit 410 and easily incorporated into the user's existing food processor 10 and storage structure 400. Importantly, the second embodiment of the storage structure 400 still allows the user to individually select any of the food processing accessories, including the dicing kit 410 without first removing any of the other accessories from the storage structure.

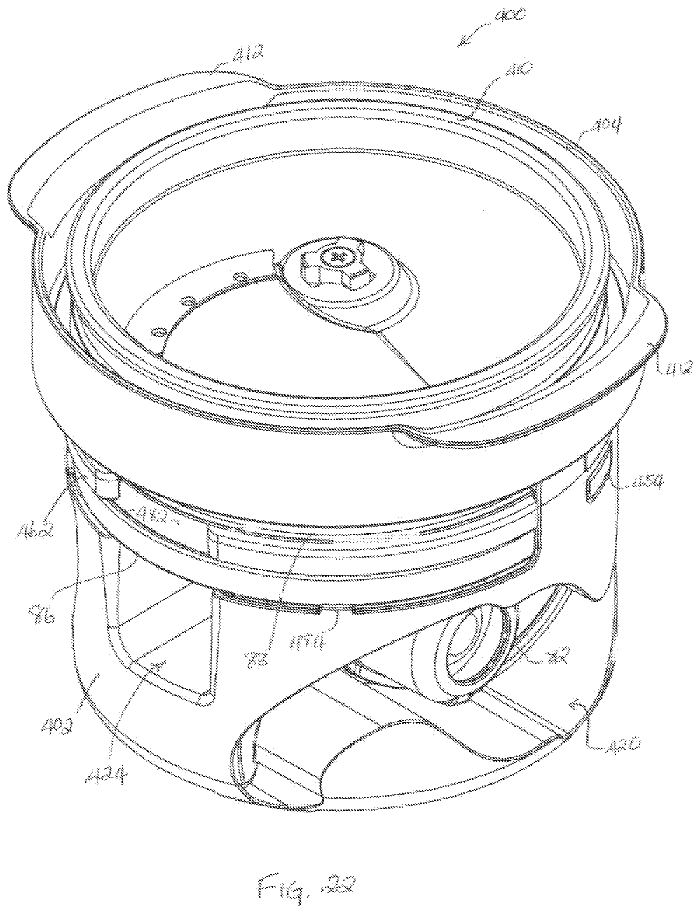

The additional unit 404 detachably engages the top surface of the base unit cover 406 using complementary bayonet features. The bayonet features allow relative rotation between the cover 406 and the additional unit 404 between locked and unlocked positions described in greater detail below with reference to FIGS. 11 and 23. However, as shown in FIG. 4, the additional unit 404 adds to the height of the storage structure 400 such that it no longer completely fits within the bowl 16. In light of this, the lid 20 may be placed onto the open top of the additional unit 404 rather than engage the bowl 16 in the usual manner. However, the storage structure 400 according to the second embodiment may still be removed from the food processor bowl 16 without requiring the user to touch any of the stored accessories. The additional unit 404 has diametrically opposed, lift tabs 412 allowing the user to simply lift the storage structure 400 clear of the food processor bowl 16. Having removed the entire storage structure 400 from the food processor 10, individual accessories may be selected and removed from the storage structure 400, including the dicing kit 410 from the open top of the additional unit 404.

The presence of the additional unit 404 between the lid 20 and the handle 18 of the bowl 16 can be used to prevent inadvertent activation of the motorized base 12. As a safety measure, food processors 10 can have a lid interlock portion and a handle interlock assembly, which in turn connects to the base to disable the motor if the bowl and the lid are not properly in place. A detailed description of the lid/handle interlock system is provided in PCT/AU2011/001578, the content of which is incorporated herein by reference. The additional unit 404 provides a convenient means of preventing the engagement of the lid interlock and the handle interlock to effectively disable activation of the motor in the motorized base 12.

FIGS. 5 and 6 are vertically sectioned views through the first and second embodiments of the storage structure 400 respectively.

FIG. 5 is a section view through the first embodiment of the storage structure 400 showing the rear half as viewed from the front in the frame of reference provided by FIG. 1. The base unit 402 has recesses 420 and 422 formed on opposing sides. The chopping blade recess 420 has as the chopping blade 82 retained on the chopping blade mount 436. The dough blade recess 422 accommodates the dough blade 84 retained on the dough blade mount 426. In the rear of the base unit 402 is an aperture 418 to hold the spindle socket 472. The spindle socket 472 has opposed gripping features 476 to detachably retain the spindle 80.

Above the base unit 402 is the cover 406. The connection between the cover 406 and the base unit 402 is described in greater detail below. However, the cover 406 and the base unit 402 together provide an adjustable slicer slot 450 and a shredding disk slot 464 to retain the adjustable slicing disk 86 and the shredding disk 88 respectively. The adjustable slicing slot 450 is separated from the shredding disk slot 464 by the partition 462. The partition 462 maintains separation between the adjustable slicing disk 86 and the shredding disk 88 during storage.

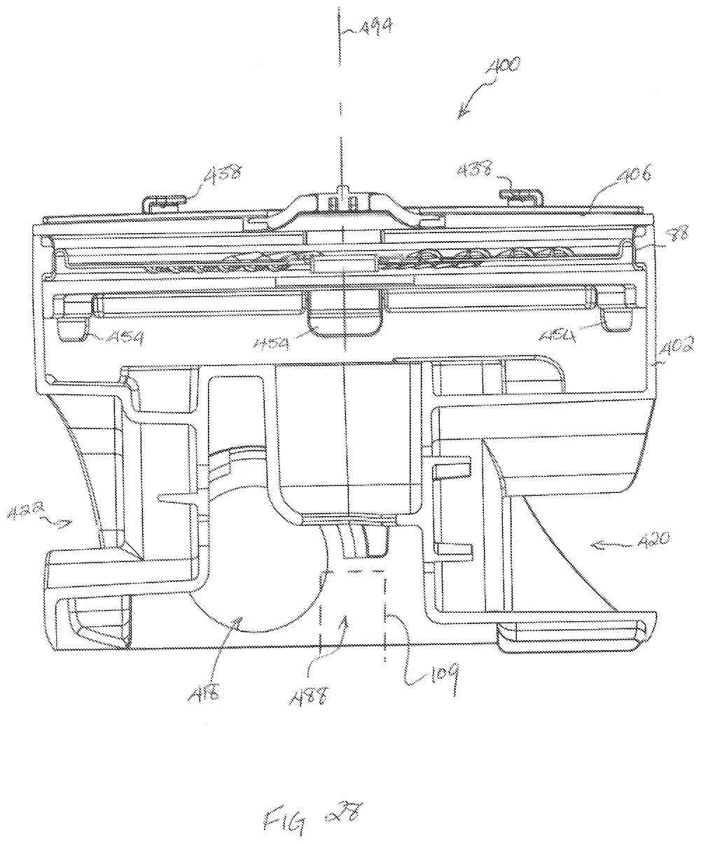

In the centre of the cover 406 is the hinged handle 408. The handle 408 rotates to an upright orientation (see FIG. 29) allowing the user to lift the first embodiment of the storage structure 400 out of the bowl 16 without needing to touch any of the accessories 82 to 88 or the spindle 80. Furthermore, with the storage structure 400 removed from the bowl 16, each of the accessories 82 to 88 are individually accessible to the user without first needing to remove any of the other accessories to gain access. Likewise, the spindle is individually accessible without needing to remove or handle other accessories. Conversely, each of the accessories are individually replaceable back into the storage unit 400 without first placing any other accessory or the drive spindle 80 back in the storage structure.

FIG. 6 is a vertically sectioned view of the second embodiment of the storage structure 400 showing the front half being viewed from the rear from the frame of reference of FIGS. 2 and 4. The second embodiment of the storage structure 400 has the additional unit 404 attached to the top of the cover 406. The additional unit 404 provides a storage pocket for an additional accessory such as a dicing kit 410. Dicing kits 410 are used for dicing or cutting hard starchy vegetables such as potatoes, turnips and sweet potatoes into chips. Some users may not require the dicing or chipping functionality from the food processor. In this case, the food processor can be purchased with the first embodiment of the storage structure 400 together with the more frequently used accessories 82 to 88. The additional unit 404 and the dicing kit 410 is an option for those requiring this functionality.

The second embodiment of the storage structure 400 still allows the user to individually access each of the accessories 82 to 88 and the dicing kit 410 without first needing to remove another of the accessories. The dicing kit 410 may be removed from the open top of the additional unit 404 while the attachment of the additional unit 404 does not impede access to the shredding disk 88 or the adjustable slicing disk 86. Furthermore, the additional unit 404 is provided with laterally extending lift tabs 412 for the user to lift the storage structure 400 out of the bowl 16 (see FIG. 4) with minimal risk of touching any of the stored accessories. Conversely the storage structure 400 is placed back into the processing bowl 16 using the lift tabs 412 without needing to physically touch any of the food processing accessories 82 to 88, spindle 80 or the dicing kit 410.

FIGS. 7 to 10 show the base unit 402 from different perspectives to depict the location of the dough blade mount 426 and the chopping blade mount 436 within the dough blade recess 422 and the chopping blade recess 420 respectively. The chopping blade recess 420 and the dough blade recess 422 retain the chopping blade 82 and the dough blade 84 such that the sharp edges are within the peripheral extent of the base unit 402. This provides a protective guard against inadvertently touching the sharp edges of these accessories for the user safety. The shape of the recesses 420 and 422 corresponds to the respective accessory, which gives a clear indication for the user to access/replace the accessory at correct locations.

The chopping blade 82 and the dough blade 84 are detachably retained in the correct position within the chopping blade recess 420 and the dough blade recess 422 respectively by the chopping blade mount 436 and dough blade mount 426. As best shown in FIG. 10, the base unit 402 has a chopping blade recess aperture 432 for receiving and engaging with the chopping blade mount bayonet tab 434. While only one aperture 432 and bayonet tab 434 are show in FIG. 10, it will be appreciated that multiple tabs and complementary apertures are provided to securely connect the chopping blade mount 436 within the chopping blade recess 420.

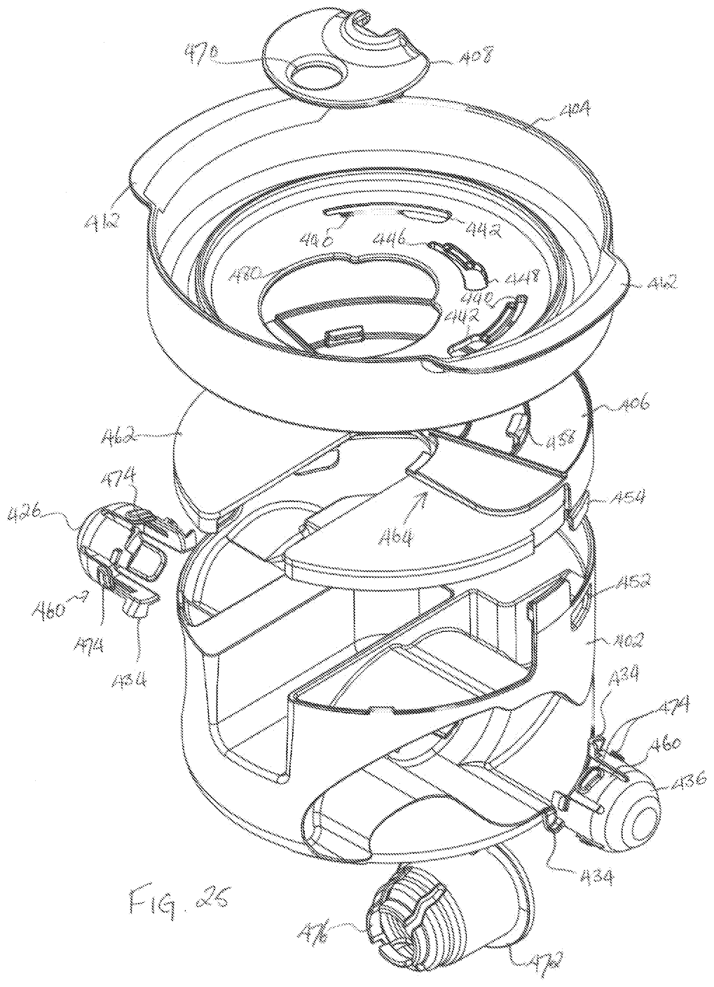

Similarly, the dough blade recess 422 has dough blade recess apertures 428 for receiving and engaging with the dough blade mount bayonet tabs 430. Both the dough blade mount 426 and the chopping blade mount 436 can be detached from the base unit 402 for cleaning if necessary and easily replaced via the bayonet connection. The accessory mounts 426 and 436 also include engagement features 474 discussed in greater detail below with reference to FIG. 26. The mounts 426 and 436 use the engagement features to detachably retain the chopping blade 82 and dough blade 84 via an interference fit allowing the user to manually remove the accessory from the respective recess while also securely retaining the accessory within the respective recess during storage.

At the top of the base unit 402 are upper extensions 416 that each support an inwardly extending capture bump 414 to resiliently retain the shredding disk 88 in the shredding disk slot 464. The inward facing capture bumps 414 are both positioned slightly forward of the diameter extending through the upward extensions 416 such that the shredding disk 88 engages both the capture bumps 414 as it is inserted into the shredding disk slot 464 just prior to the widest point (i.e. a diameter of the disk). A degree of flexibility in the upward extensions 416 allows the shredding disk 88 to be pushed through the capture bumps 414 past the widest point provided by the diameter to a position just past the diameter to retain the disk in the slot via what is effectively an over centre mechanism.

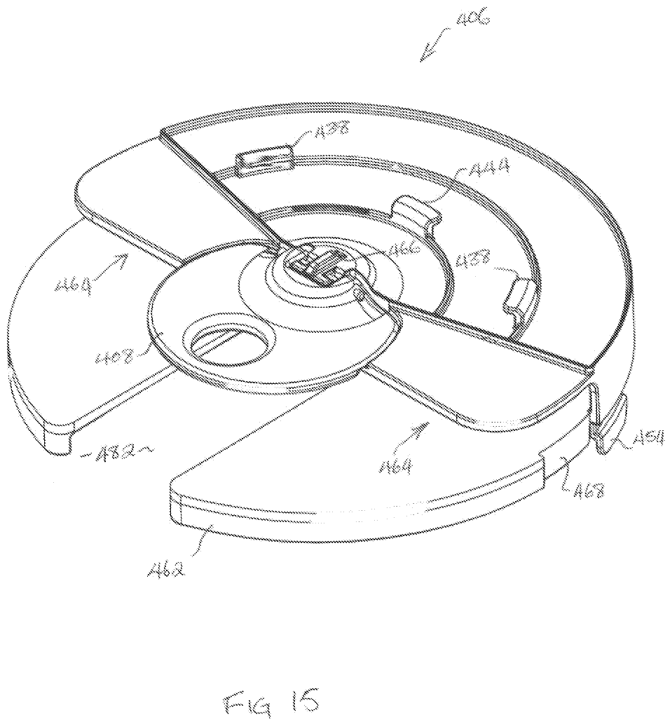

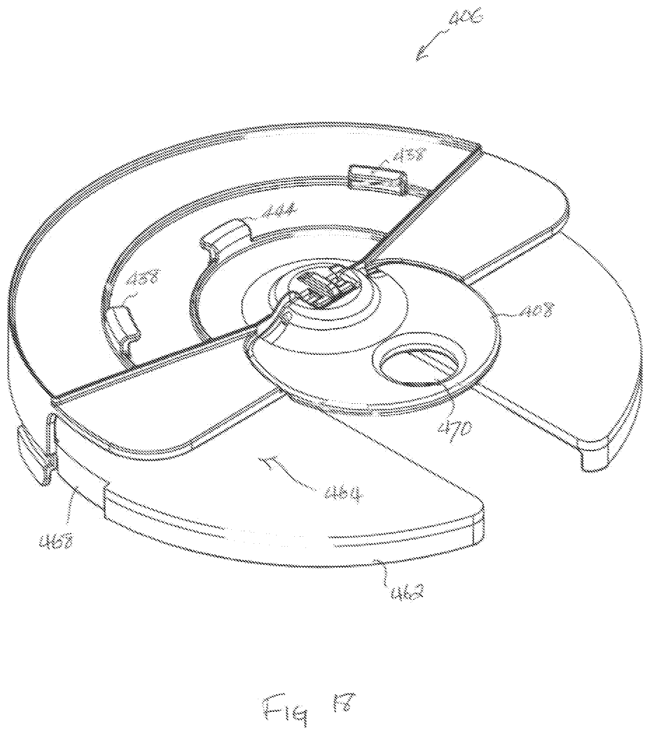

The top of the base unit 402 also has side wall apertures 452 formed in the side wall directly beneath guide ramps 458 formed in the top rim of the side wall. These features are used in the snap-locking interconnection between the base unit 402 and the cover 406. This snap-lock connection is discussed in greater detail below with reference to FIGS. 15 to 18. At the front of the base unit 402 is a finger access recess 424 extending between the chopping blade recess 420 and the dough blade recess 422. The finger access recess 424 allows the user to easily access and retrieve the adjustable slicing disk 86. As discussed below with reference to FIGS. 15 to 18, a gap in the partition 462 separating the shredding disk and the adjustable slicer provides finger access to the top side of the adjustable slicing disk 86 for the user to grip and draw it from the adjustable slicer slot 450.

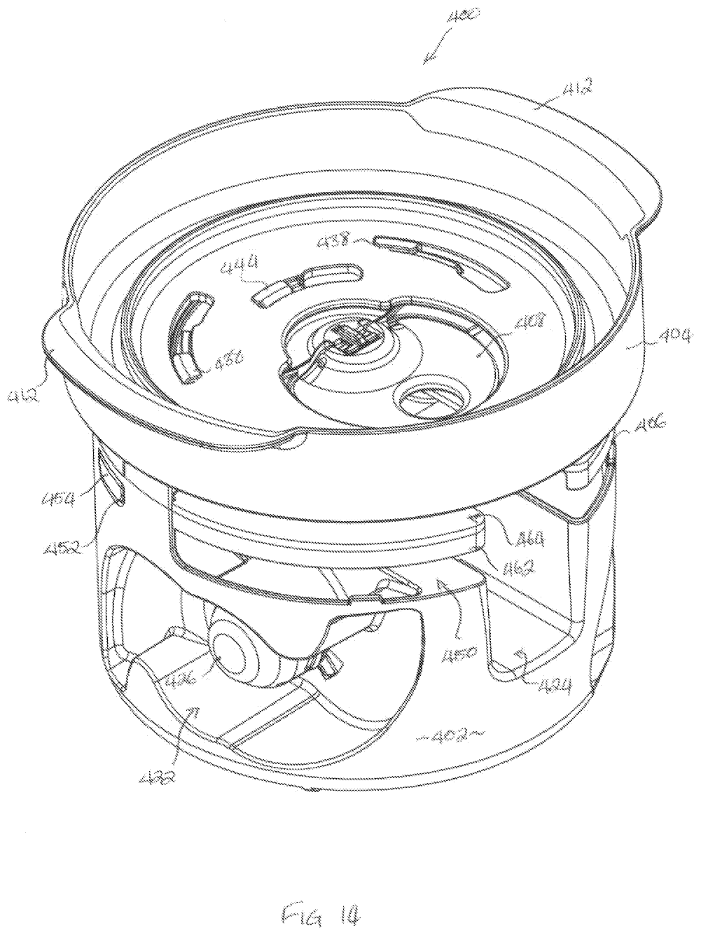

FIGS. 11 to 14 are different perspectives of a storage structure 400 according to the second embodiment with the additional unit 404 in the locked position on the cover 406 of the base unit 402. The additional unit 404 connects to the top surface of the base unit cover 406 via a bayonet connection provided by the inwardly bent tabs 438, the outwardly bent tab 444 and the arcuate slots 440 and 446. The inwardly bent tabs 438 engage the two long arcuate slots 440 positioned at a greater radial distance from the centre of the additional unit 404 than the shorter arcuate slot 446. By relative rotation of the additional unit 404 and the cover 406, the inwardly bent tabs 438 and the outwardly bent tab 444 move to the other end of the slots 440 and 446. This position is an unlock position (see FIG. 23) allowing removal of the additional unit 404 from the cover 406 when the inwardly bent tabs 438 align with the inward tab opening 442 and the outwardly bent tab 444 aligns with the outward tab opening 448.

The additional unit 404 incorporates a handle access opening 480 that aligns with the lift handle 408 when in the locked position. In the event the dicing kit 410 is not in the additional unit 404 and the user chooses to lift the storage structure 400 via the hinged lift handle 408, the handle access opening 480 allows access to the finger hole 470 and rotation of the handle 408 to the upright orientation (see FIG. 29).

FIGS. 15 to 18 show different perspectives of the cover 406 for the base unit 402. The top of the cover 406 is provided with the inwardly bent tabs 438 positioned at a greater radial distance from the centre of the cover than the outwardly bent tab 444. Proximate the centre of the cover 406 is the hinge connection 466 for the lift handle 408. At the bottom of the cover 406 is a partition 462 for separating the adjustable slicer slot 450 and the shredding disk slot 464. As previously discussed, the partition 462 includes a gap 482 at the front to align with the finger access recess 424 in the base unit 402 so that the user can grip the rim of the adjustable slicing disk 86 (when stored in the adjustable slicer slot 450, see FIG. 11).

On the left and right sides of the cover 406 are peripheral locating recesses 468. When the cover 406 moves into snap locking engagement with the base unit 402 the upper extensions 416 on the top of the base unit 402 (see FIG. 7) extend through the peripheral located recesses 468 such that the inward facing capture bumps 414 are positioned within the shredding disk slot 464.

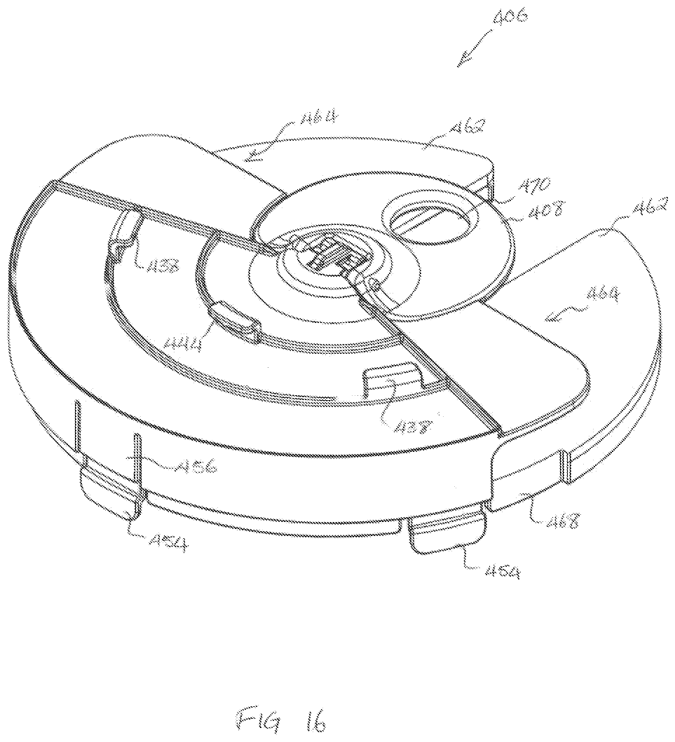

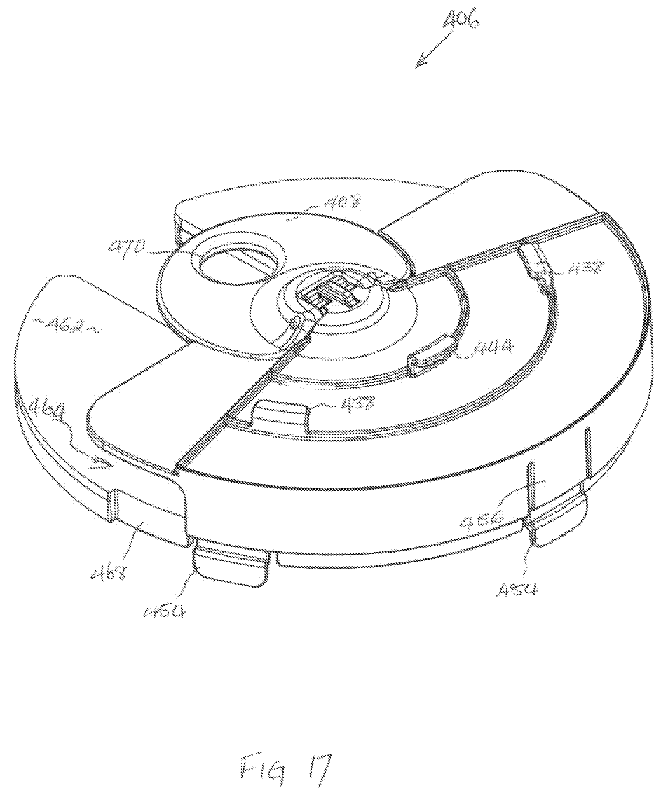

As best shown in FIGS. 16 and 17, the rear, lower periphery of the cover 406 includes downwardly extending snap locking tabs 454. For increased flexibility, the middle snap locking tab 454 is mounted to a flexible base section 456. The snap locking tabs 454 are positioned to engage the guide ramps 458 in the top rim of the base unit 402 (see FIG. 7). As the cover 460 is pushed downwards, the snap locking tabs 454 slide down the guide ramps 458 and eventually snap lock into the side wall apertures 452. Alternatively, the cover 406 may be permanently attached or integrally form with the base unit 402.

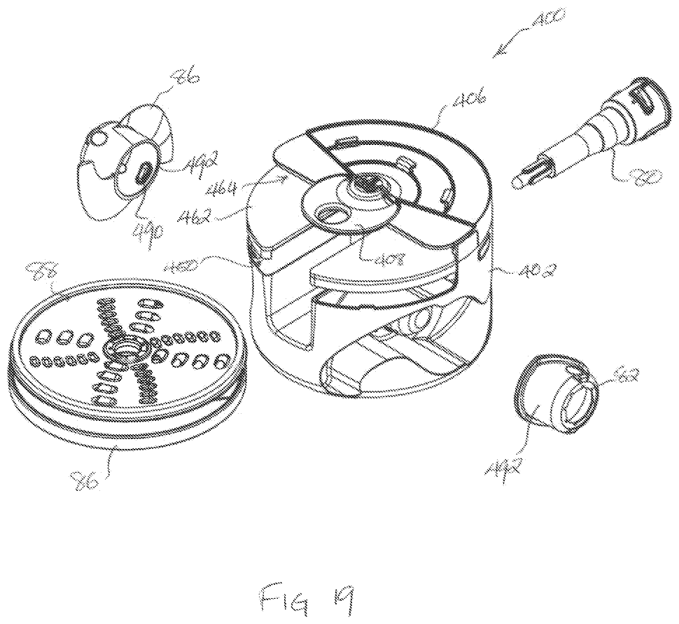

FIG. 19 shows the first embodiment of the storage structure 400 with the various accessories separated away from their respective storage positions. This depicts how the chopping blade 82 is individually accessible from the right side of the storage structure 400, (from the perspective shown in the figures) the dough blade 84 is accessible from the left side, the adjustable slicing disk and the shredding disk 86 and 88 may be individually drawn out from the front of the slots 450 and 464 respectively while the spindle 80 is retrieved from the rear of the storage structure 400. In this way, the user is not required to handle any accessory other than the accessory needed to perform the desired food processing function. It will be understood that the storage structure 400 can be placed in the bowl 16 in any orientation, and references to ‘left’, ‘right’ and ‘front’ used above do not imply these features face left, right or front during use.

Similarly, the exploded perspective of the second embodiment of the storage structure 400 shows the attachment of the additional unit 404 does not prevent individual access and removal of the chopping blade 82, dough blade 84, the slicing disk 86, the shredding disk 88, or the spindle 80. Furthermore, the dicing kit 410 is individually accessible from the open top of the additional unit 404.

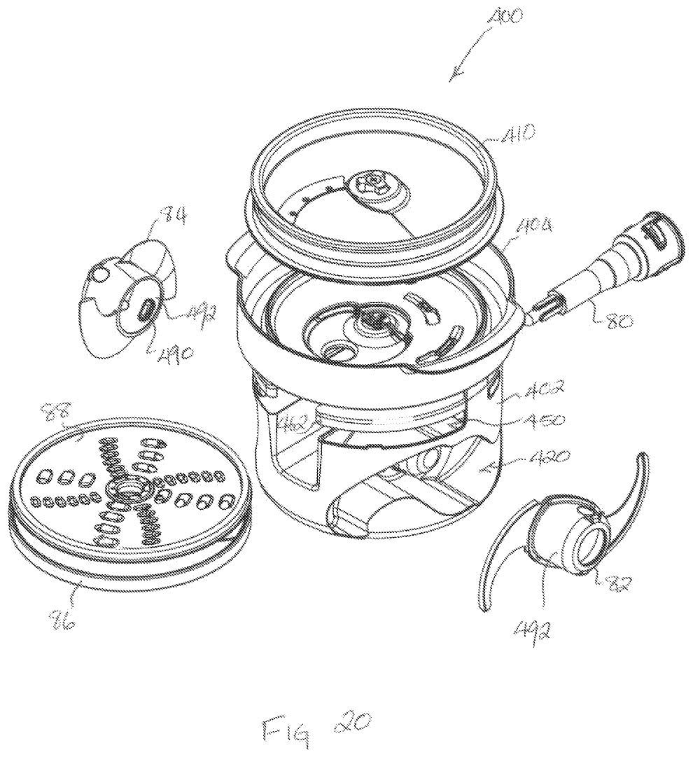

FIG. 21 is a front, right side perspective of the first embodiment of the storage structure 400 showing the adjustable slicing disk 86 stored within the adjustable slicer slot 450 and the grating disk 88 stored within the grating disk slot 464. Access to these disks for removal and replacement is by the finger access recess 424 in the front of the base unit 402 and the front gap 482 in the partition 462 of the cover 406. The thickness of the partition 462 is sufficient to allow users to gain a finger grip on the rim of the adjustable slicing disk 86 and the peripheral rim of the grating disk 88. The finger grip should provide enough purchase on the disks to allow the user to lift the adjustable slicing disk over the disk retention tabs 484 while the shredding disk 88 is to be drawn out of the shredding disk slot 464 past the resistance provided by the disk capture bumps 414.

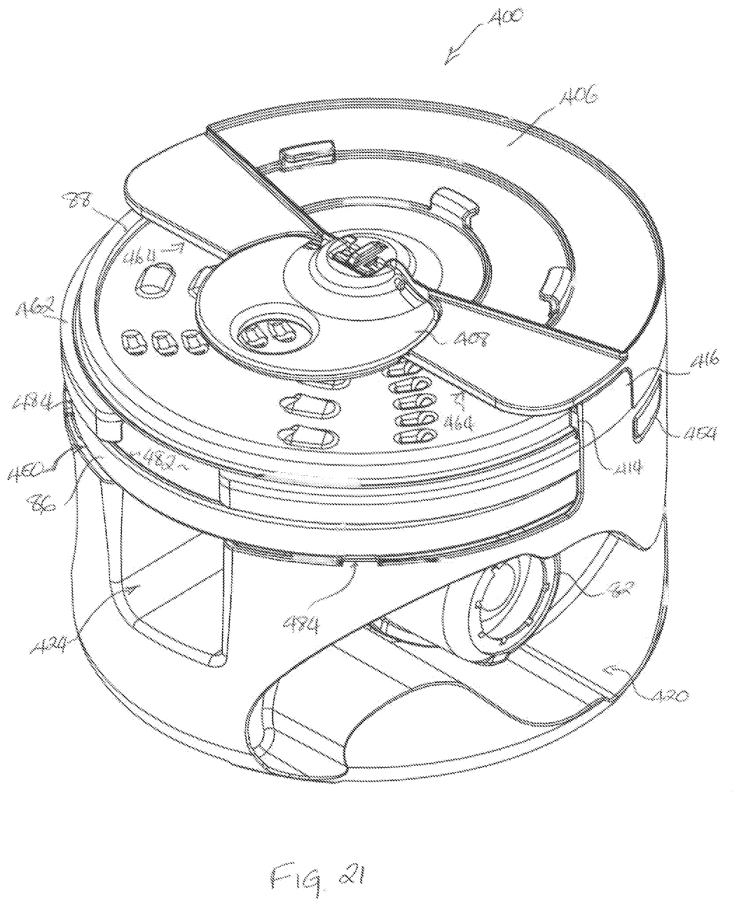

FIG. 22 shows the second embodiment of the storage structure 400 depicting how the shredding disk 88 is still accessible for individual removal via the front gap 482 in the partition 462. With the additional unit 404 attached to the top of the cover 406, a gap remains beneath the base of the additional unit and the rim of the shredding disk 88 allowing sufficient finger grip for removal and replacement of the shredding disk 88.

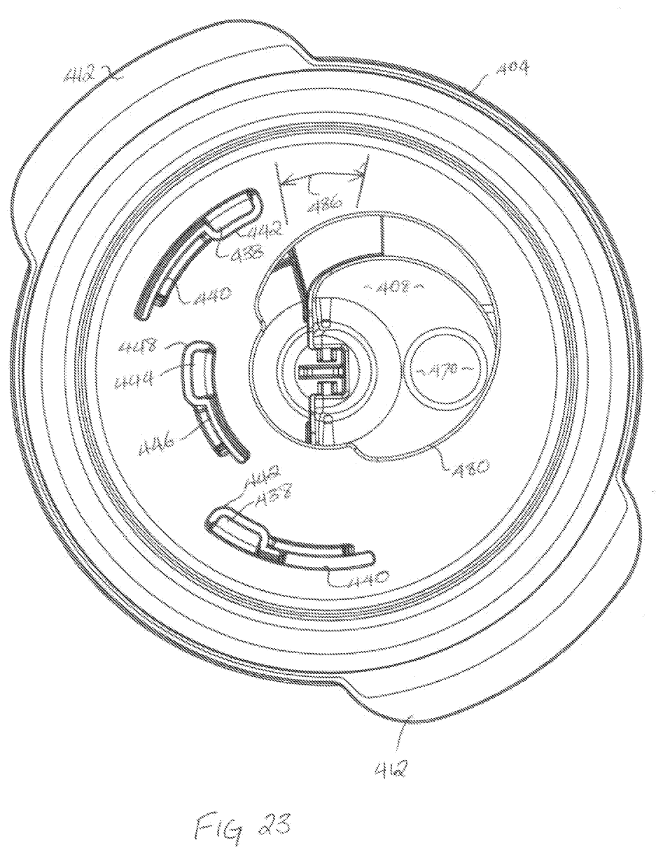

FIGS. 23 and 24 show the additional unit 404 rotated to the unlocked position on the cover 406. As discussed above, FIG. 11 shows the additional unit 404 in the locked position. Rotating the additional unit 404 relative to the base unit 402 through the predetermined angle 486 unlocks the additional unit 404 from the cover 406. As previously described, the additional unit 404 and the cover 406 engage via a bayonet connection between the inwardly bent tabs 438 and outwardly bent tab 444 on the cover 406 and the long arcuate slots 440 and short arcuate slot 446 in the additional unit 404. In the unlocked position, the inwardly bent tabs 438 are within the inward tab openings 442 at the end of the long arcuate slots 440. Likewise, the outwardly bent tab 444 is within the outward tab opening 448 at the end of the short arcuate slot 446. This constitutes the unlocked position of the bayonet connection such that the additional unit 404 can be lifted off the cover 406 using the lift tabs 412.

In the unlocked position, the user is not able to lift the storage structure 400 via the hinged handle 408 on the cover 406. Once the additional unit 404 has been rotated through angle 486 relative to the cover 406, the handle access opening 480 is no longer in registration with the hinged lift handle 408 beneath.

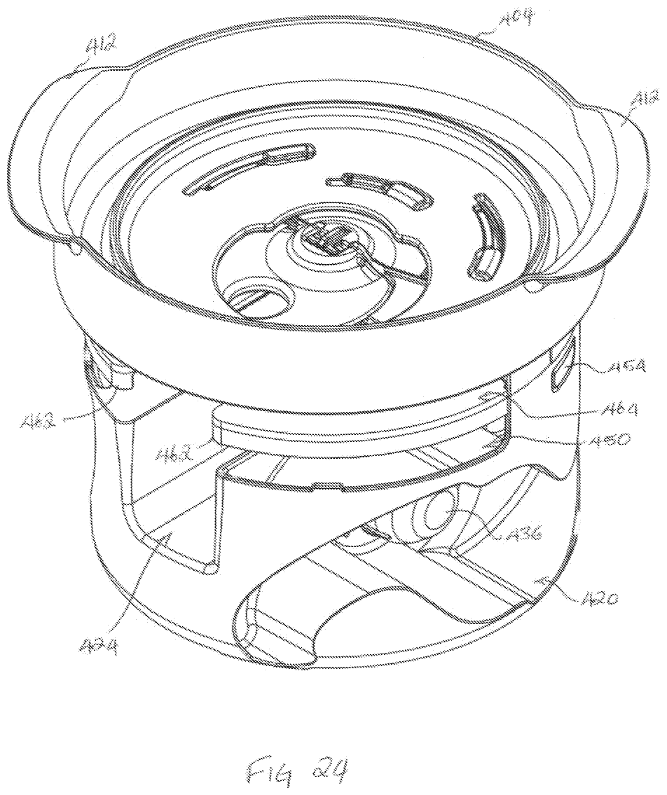

FIG. 25 is an exploded perspective of the second embodiment of the storage structure 400 showing the spindle socket 472, the chopping blade mount 436 and the dough blade mount 426 removed from the base unit 402 for clarity.

FIG. 26 is a perspective of the base unit 402 together with the spindle socket 472, the chopping blade mount 436 and the dough blade mount 426 separated to clearly depict their respective detachable engagement features. The spindle socket 472 has spindle gripping features 476 that are biased into gripping engagement with the sides of the spindle 80 when it is inserted in the socket 472. The strength of the engagement between the spindle griping features 476 and the spindle 80 is configured such that the spindle is securely retained within the socket 472 but easily removed via the user without excessive effort.

The chopping blade mount 436 and the dough blade mount 426 have detachable engagement features 474 positioned about their respective side walls. The chopping blade mount 436 and the dough blade mount 426 depicted in the Figures have three engagement features 474 each however it will be appreciated that other detachable engagement formations are possible. The detachable engagement features 474 are mounted in a flexible manner to compress inwards as the hub 492 of the accessories 82 and 84 are pushed onto their respective mounts (see FIGS. 19 and 20). The interior of the accessory mount hubs 492 have a complementary set of retention detents 490 to receive the outwardly biased engagement features 474. Once again, the engagement between the engagement features 474 on the accessory mounts 436 and 426 and the accessory hubs 492 is sufficient to securely retain the chopping blade 82 and the dough blade 84 during storage and removal from the bowl 16, but manually removable without excessive effort.

FIGS. 25 and 26 provide a clear depiction of the dough blade mount bayonet tabs 430 and the chopping blade mount bayonet tabs 434. As with the engagement features 474, each of the accessory mounts 426 and 436 are provided with three bayonet tabs (three tabs 430 and three tabs 434) respectively. However, it will be appreciated that other forms of detachable engagement between the accessory mounts 426 and 436 and the base unit 402 would be possible.

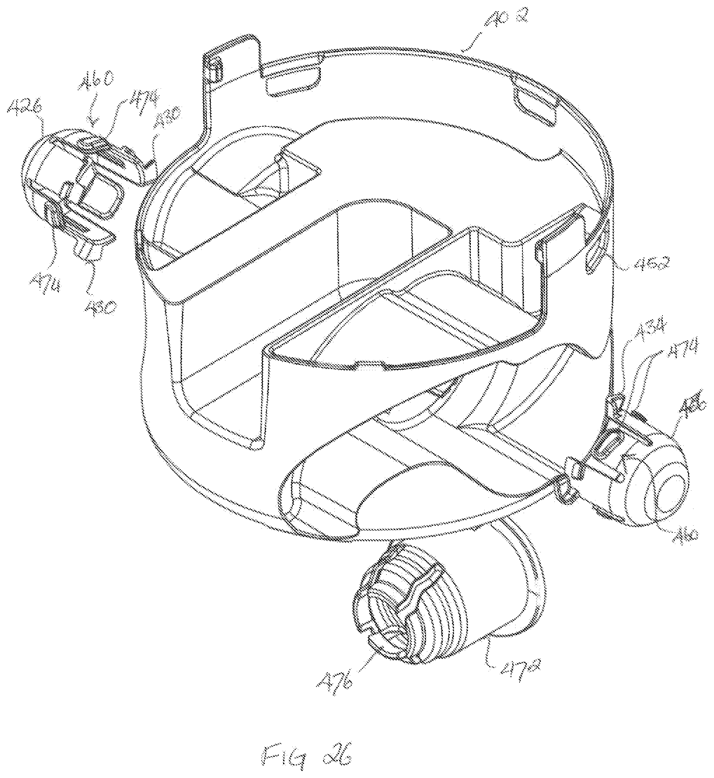

FIG. 27 is a left side elevation of the storage structure 400 according to the first embodiment. This provides a clear depiction of the features in the recess provided bayonet style engagement with the dough blade mount 426. Within the dough blade recess 422 are three equally spaced, concentric arcuate recesses 428. At one end of each of the arcuate recesses 428 is a bayonet tab opening 478. The bayonet tab openings 478 are sized to allow the dough blade mount bayonet tabs 430 to pass through whereupon relative rotation of the dough blade mount 426 and the base unit 402 moves the bayonet coupling to the locked position.

The situation is repeated on the other side of the base unit 402 in the chopping blade recess 420 where the chopping blade recess apertures 432 are three, arcuate, equi-spaced concentric grooves. Likewise, the chopping blade recess apertures 432 include bayonet tab openings to allow the chopping blade mount tab 434 to pass through. Relative rotation of the chopping blade mount 436 and base unit 402 moves the bayonet coupling to the locked position.

FIG. 28 is a vertical cross section of the rear half of the storage structure 400 according to the first embodiment. In the centre of the underside of the base unit 402 is a drive coupling cavity 488. When the storage structure 400 is placed within the processing bowl 16, the spindle drive coupling 109 protruding from the base of the bowl is accommodated wholly within the drive coupling cavity 488. This isolates the drive coupling on the base of the bowl from any contact with parts of the storage structure 400 or the accessories and spindle stored therein. Hence, the storage structure 400, the stored spindle 80 and accessories 82 to 88 are protected from damage due to inadvertent activation of the motorised base 12.

FIG. 29 is a perspective showing the first embodiment of the storage structure 400 with the lift handle 408 rotated to the upright orientation. In the upright orientation, the handle 408 positions the finger hole 470 such that the central axis 494 of the storage structure 400 is substantially colinear with a diameter of the circular finger hole 470. In this way, the storage structure 400 stays substantially level as it is lifted from the processing bowl 16 (not shown).

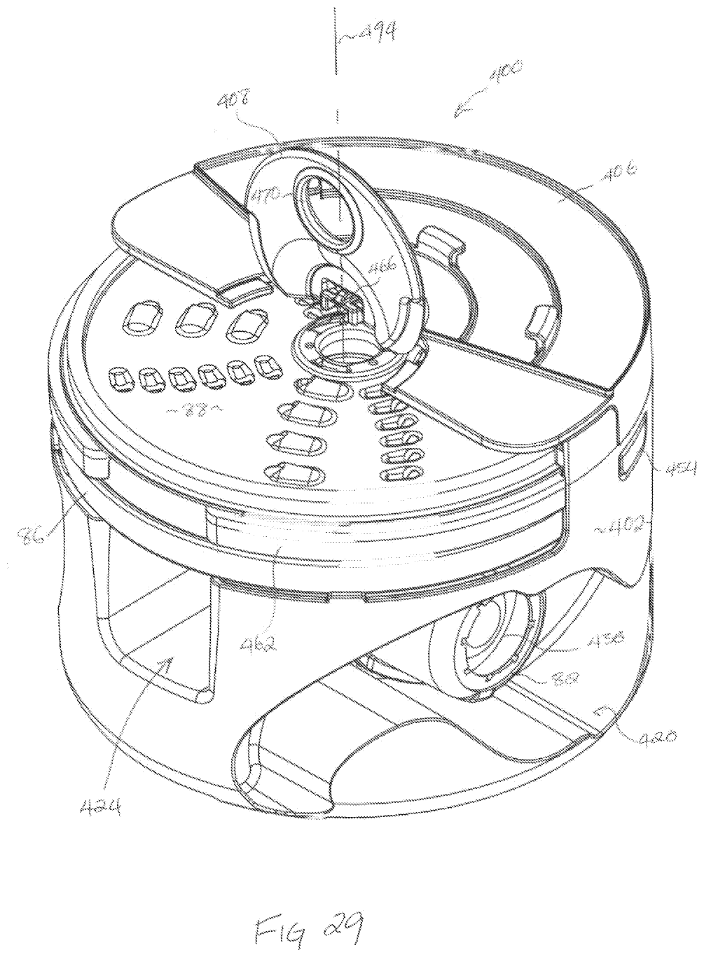

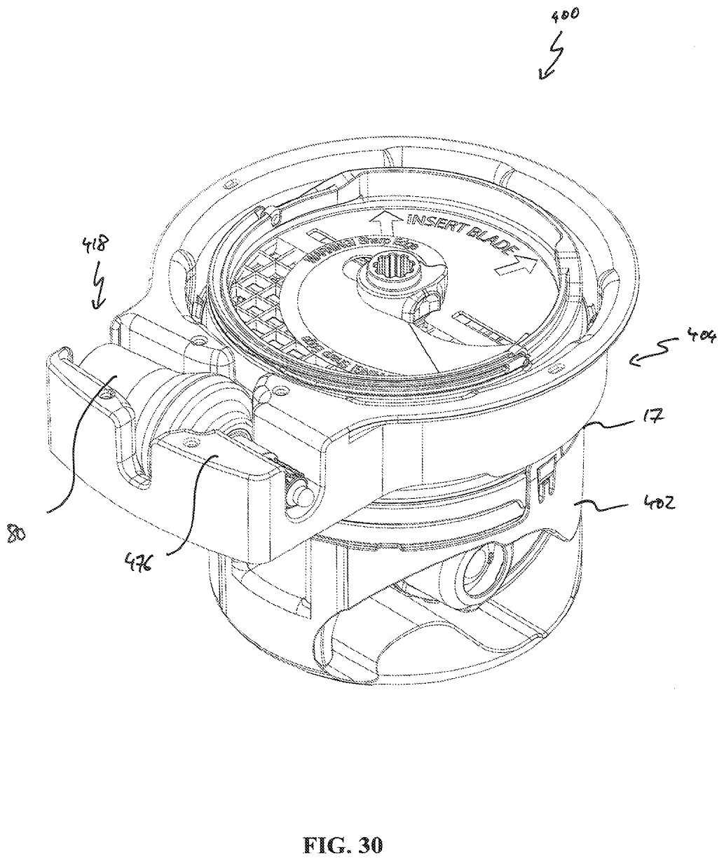

FIGS. 30 to 39 show another embodiment of the storage structure 400. The storage structure 400 of FIGS. 30 to 39 is substantially similar to the storage structure 400 of previously discussed embodiments, except for the features shown and discussed herein.

As shown in FIG. 30, the storage structure 400 also includes an additional unit 404 for retaining a further accessory, such as the dicing kit 410. The additional unit 404 includes a spindle recess 418 located external of a perimeter 17 of the base unit 402. The spindle recess 418 includes spindle gripping features 476 to retain the spindle 80 in the spindle recess 418. Preferably, the spindle recess 418 is disposed such that the spindle 80, when retained by the spindle recess 418, extends substantially in the plane of the additional unit 404.

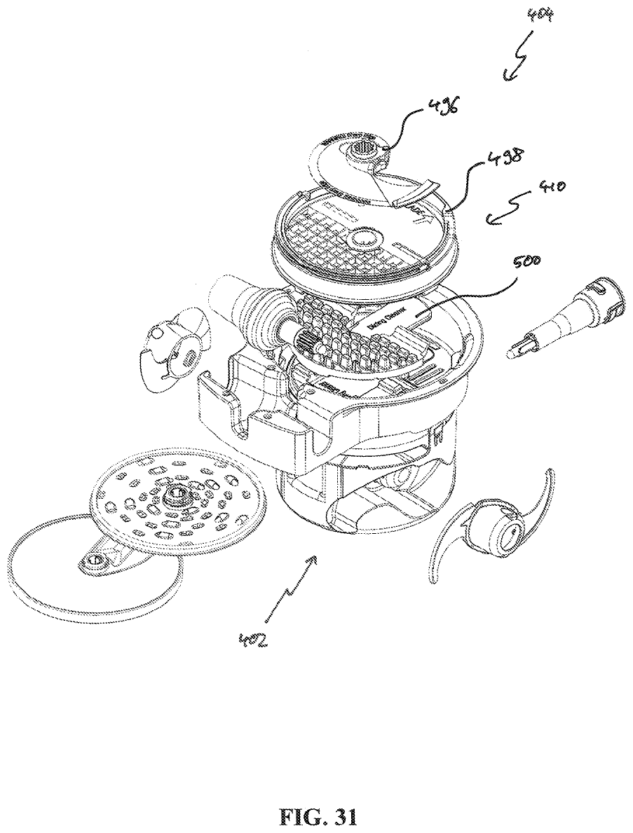

Moving now to FIG. 31, where it can be seen that the additional unit 404 provides retention space for the dicing kit 410. The dicing kit 410 includes a dicing blade 496, a dicing matrix 498, and a matrix cleaner 500. The dicing kit 410 is described in more detail in PCT Patent Application No. PCT/AU2021/050774, which is incorporated herein in its entirety by reference thereto.

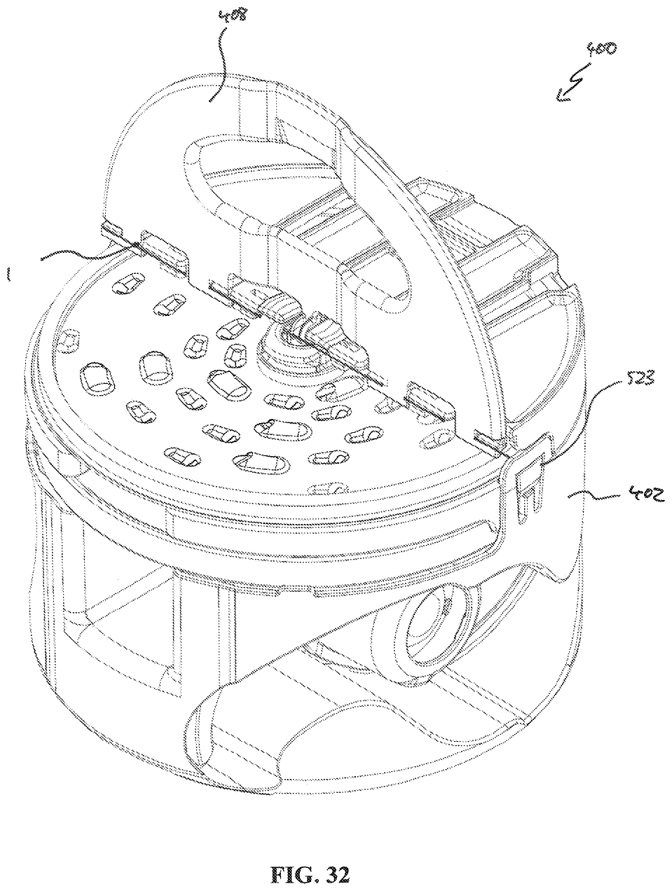

In this embodiment, as seen in FIG. 32, the storage structure 400 also includes a hinged lift handle 408. In this embodiment, the base unit 402 has a diameter 19 and the lift handle 408 is connected to the base unit 402 across substantially the whole diameter 19.

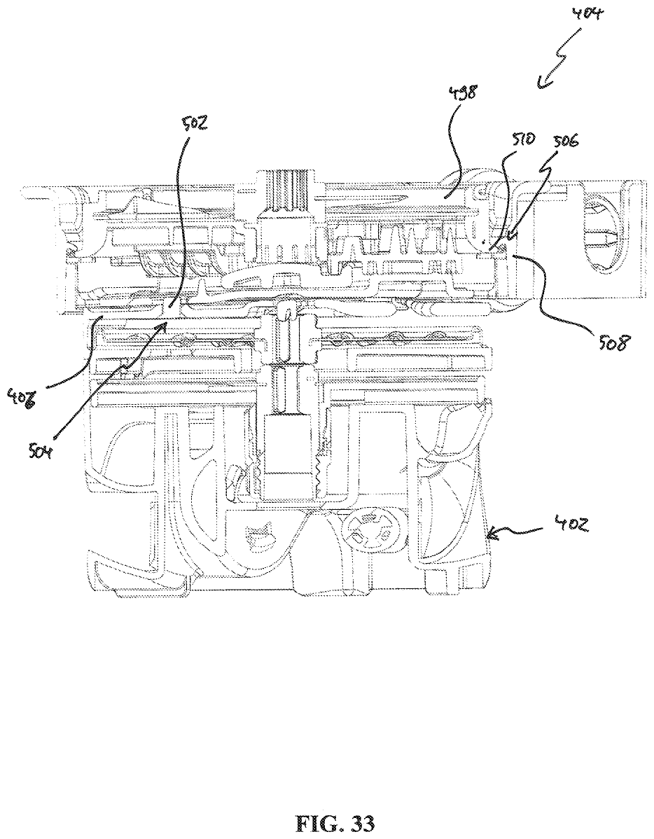

Moving now to FIG. 33, where it can be seen that the additional unit 404 attaches to the base unit 402 by a sliding engagement of one or more protrusions 502 of the additional unit 404 into a respective channel 504 of the base unit. Preferably the protrusions 502 extend linearly. The engagement of the protrusions 502 with the channel 504 prevents movement of the additional unit 404 relative to the base unit cover 406, in particular movement normal to the base unit cover 406. As can also be seen in this figure, the additional unit 404 includes a recess 506 along a rim 508 of the additional unit 404. The recess 506 is configured to be releasably engaged by an outer edge 510 of the dicing matrix 498 to retain the dicing matrix 498 in the additional unit 404.

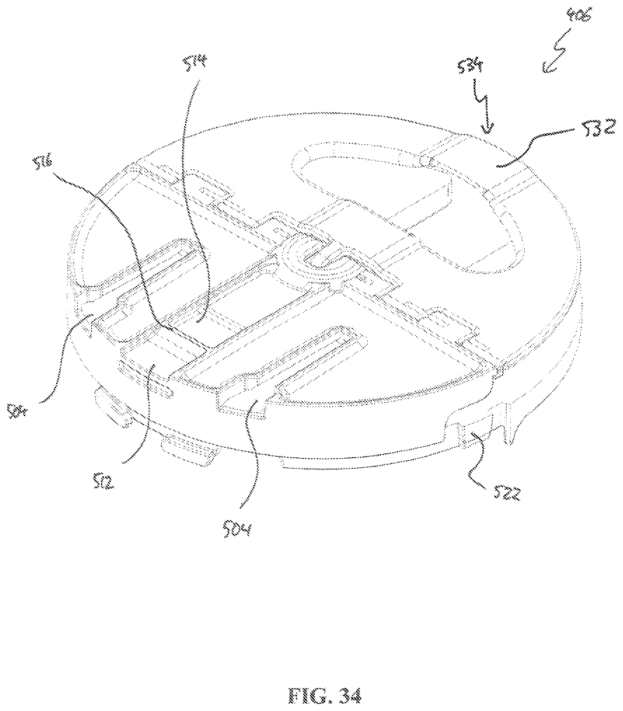

FIG. 34 shows the base unit cover 406 of this embodiment, and in particular shows the channels 504 that are engaged by the protrusions 502 of the additional unit 404. The channels 504 are substantially linear and extend parallel to each other, and perpendicularly to a hinge axis of the hinged lift handle. The base unit cover 406 further includes a ramp 512 extending parallel to the channels 504 towards a first recess 514 with substantially the same width as the ramp 512. The first recess 514 is separated from the ramp 512 by a wall 516. The base unit cover 406 further includes a second recess 518 in a sidewall 520, as best seen in FIG. 38. As also seen in FIG. 34, the base unit cover 406 includes a protrusion 522 that is configured to form a snap fit with a recess 523 formed in the base unit 402, as shown in FIG. 32.

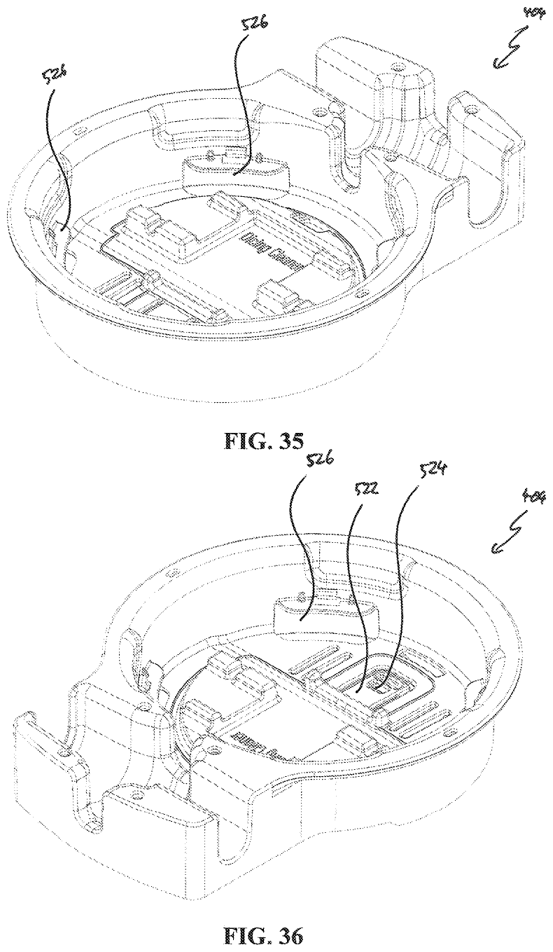

Moving now to FIGS. 35 and 36, which shows the additional unit 404 in more detail. In particular, as seen in FIG. 36, the additional unit 404 includes a tongue 522 that is disconnected on three edges from the additional unit 404, thereby providing a living hinge allowing hinging of the tongue 522 relative to the additional unit 404. The tongue 522 includes a through hole 524, allowing a tool (not shown) to be passed through the hole 524 to allow lifting of the tongue 522. The additional unit 404 further matrix cleaner retention features 526 to retain the matrix cleaner 500 in the additional unit 404, and lift the dicing matrix 498 to create a space to store the matrix cleaner 500.

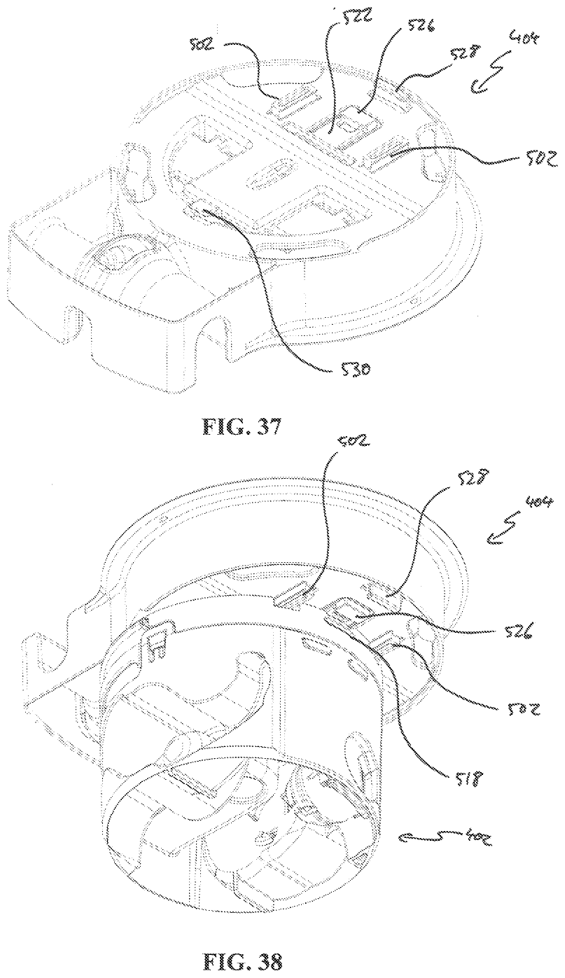

Moving now to FIG. 37, which shows the additional unit 404 from below. The tongue 522 includes a protrusion 526 adapted to slide across the ramp 512 when the protrusions 502 slidingly engage the channels 504. The tongue 522 hinges as the protrusion 526 is engaged by the ramp 512, until the protrusion 526 has travelled beyond the wall 516, when the tongue 522 flexibly returns to its starting position, with the protrusion 526 engaged in the first recess 514. The engagement of the protrusion 526 with the first recess 514 prevents movement of the additional unit 404 relative to the base unit cover 406.

The additional unit 404 further includes an l-shaped hook 528 that is adapted to engage the second recess 518 in the sidewall 520 when the additional unit 404 is engaged with the base unit cover 406. The engagement of the hook 528 with the second recess 518 prevents rotation of the additional unit 404 relative to the base unit cover 406. The additional unit 404 further includes a backstop 530 extending from the additional unit 404 so as to be hingeable when the additional unit 404 slides onto the base unit cover 406. The backstop 530 is generally L-shaped so as to be engageable with the base unit cover 406. Specifically, the backstop 530 is located so as to engage a raised portion 532 of the hinged lift handle 408. The raised portion 532 is preferably located at an apex 534 of the hinged lift handle 408. Preferably, the raised portion 532 is tapered towards the backstop 530, such that the engagement of the backstop 530 with the raised portion 532 is facilitated.

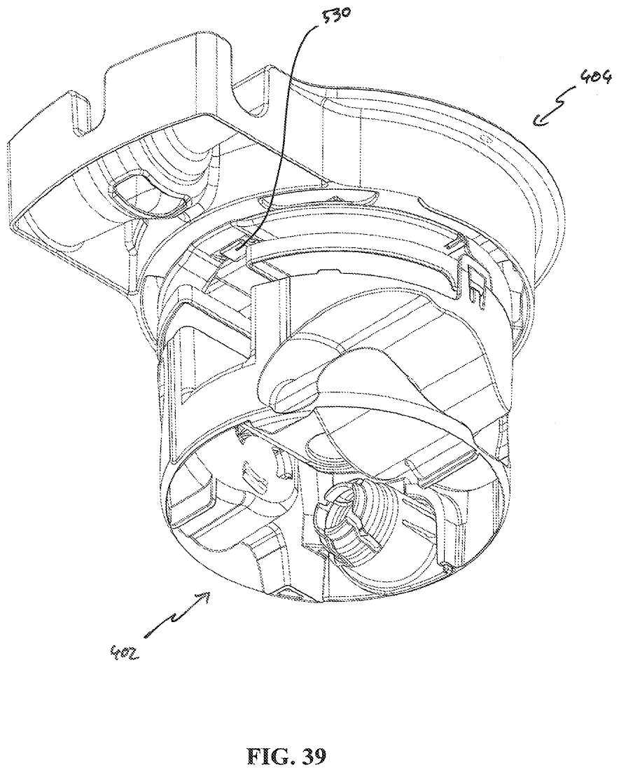

Moving now to FIG. 38, which shows the additional unit 404 about to be engaged with the base unit 402, and FIG. 39, which shows the additional unit 404 engaged with the base unit 402. As seen in FIG. 39, the backstop 530 engages the raised portion 532 once the additional unit 404 has fully engaged the base unit cover 406. Furthermore, the backstop 430 assists in preventing movement of the additional unit 404 relative to the base unit cover 406.

The invention has been described herein by way of example only. Skilled workers in this field will readily arrive at many variations and/or re-combinations of the previously discussed embodiments which do not depart from the spirit and scope of the broad inventive concept.

### INTEGERS

| | |
|---|---|
| 10 | Food processing device |
| 11 | Drive socket |
| 12 | Motorised base |
| 14 | Interface |
| 16 | Bowl |
| 17 | Perimeter |
| 18 | Handle |
| 20 | Lid |
| 22 | Feed tube |
| 24 | Pusher |
| 80 | Spindle |
| 82 | Chopping blade |
| 84 | Dough blade |
| 86 | Adjustable slicer |
| 88 | Shredding disk |
| 108 | Base interlock assembly |
| 109 | Spindle drive coupling |
| 400 | Storage structure |
| 402 | Base unit |
| 404 | Additional unit |
| 406 | Base unit cover |
| 408 | Hinged lift handle |
| 410 | Dicing kit |
| 412 | Lift tabs |
| 414 | Capture bumps |
| 416 | Upper extensions |
| 418 | Spindle recess |
| 420 | Chopping blade recess |
| 422 | Dough blade recess |
| 424 | Finger access for disk removal |
| 426 | Dough blade mounts |
| 428 | Dough blade recess aperture |
| 430 | Dough blade mount bayonet tabs |
| 432 | Chopping blade recess aperture |
| 434 | Chopping blade mount bayonet tab |
| 436 | Chopping blade mount |
| 438 | Inwardly bent tabs |
| 440 | Long arcuate slot |
| 442 | Inward tab opening |
| 444 | Outwardly bent tab |
| 446 | Short arcuate slot |
| 448 | Outward tab opening |
| 450 | Adjustable slicer slot |
| 452 | Side wall apertures |
| 454 | Snap locking tabs |
| 456 | Flexible section |
| 458 | Guide ramps |
| 460 | Accessory retention features |
| 462 | Partition to separate shredding disk |
| | and adjustable slicer |
| 464 | Shredding disk slot |
| 466 | Handle hinge |
| 468 | Peripheral locating recesses |
| 470 | Finger hole |
| 472 | Spindle socket |
| 474 | Engagement features |
| 476 | Spindle gripping features |
| 478 | Bayonet tab openings |
| 480 | Handle access opening |
| 482 | Partition gap |
| 484 | Retention tabs |
| 486 | Angle of relative rotation |
| 488 | Drive coupling cavity |
| 490 | Retention detent |
| 492 | Blade accessory hub |
| 494 | Central axis of storage structure |
| 496 | dicing blade |
| 498 | dicing matrix |
| 500 | matrix cleaner |
| 502 | protrusion |
| 504 | channel |
| 506 | recess |
| 508 | rim of additional |
| 510 | outer edge of dicing |
| 512 | ramp |
| 514 | first recess |
| 516 | wall |
| 518 | second recess |
| 520 | sidewall |
| 522 | tongue |
| 524 | through hole |
| 526 | protrusion |
| 528 | hook |
| 530 | backstop |
| 532 | raised portion |
| 534 | apex |

1. A storage structure for a food processing device with a bowl for processing food using different accessories, the storage structure comprising:
a base unit configured to fit within the bowl, and
engagement formations to retain a plurality of the accessories on the base unit for individual removal from the base unit, and replacement into the base unit, without first removing or replacing another of the accessories.

2. The storage structure according to claim 1 wherein the base unit has recesses to store the accessories, each of the recesses having at least one of the engagement formations to detachably engage the accessories such that the accessories are stored within the recesses to prevent direct contact of one of the accessories with another of the accessories.

3. The storage structure according to claim 1 or 2 wherein the food processing device has a spindle to engage the accessories for rotation within the bowl, and some of the engagement formations are configured to retain the spindle, such that the spindle is removable from the base unit without requiring removal of any of the accessories stored in the base unit.

4. The storage structure according to claim 3 wherein the base unit has a socket to receive the spindle, the socket having a plurality of the formations for detachably gripping the spindle during storage and allowing manual removal of the spindle by a user.

5. The storage structure according to claim 3 wherein at least one of the recesses is configured for storing a designated one of the accessories only.

6. The storage structure according to claim 5 further comprising a removable mount in the at least one recess, the removable mount having the formations to detachably engage the accessory for storage within the recess.

7. The storage structure according to claim 6 wherein, the removable mount and the at least one recess have complementary bayonet tabs and apertures forming a bayonet connection between the mount and the recess.

8. The storage structure according to any one of claims 1 to 7 further comprising a cover for attachment to the base unit, the cover and the base unit defining at least one slot to retain one of the accessories formed as a disk for rotation in the bowl.

9. The storage structure according to claim 8 wherein the cover and the base unit define a plurality of the slots to individually retain one of the disks respectively.

10. The storage structure according to claim 8 or 9 further comprising an additional unit for detachable engagement with the cover, the additional unit being configured to hold an additional accessory for the food processing device, such that the additional unit does not prevent removal of any of the plurality of accessories stored in the storage structure.

11. The storage structure according to claim 10 wherein the food processing device has a lid for the bowl wherein the additional unit is configured to receive the lid to cover the additional accessory.

12. The storage structure according to any one of claims 1 to 11 wherein the bowl has a base with a spindle drive coupling, and the storage structure further comprises a drive coupling cavity for accommodating the spindle drive coupling when the base unit is within the bowl such that the spindle drive coupling does not touch any part of the storage structure or the plurality of accessories.

13. The storage structure according to any one of claims 1 to 12 configured to be lifted out of the bowl without requiring user contact with any of the accessories.

14. The storage structure according to claim 13 wherein the cover has a lift handle with hinged connection for rotation to an upright orientation to lift the storage structure from the bowl.

15. The storage structure according to claim 14, wherein the hinged connection of the lift handle extends wholly across a diameter of the base unit.

16. The storage structure according to any one of claims 13 to 15 wherein the additional unit has lift tabs for lifting the storage structure from the bowl.

17. The storage structure according to claim 8 or 9, wherein the storage structure further comprises an additional unit for detachable engagement with the cover, the additional unit being configured to hold an additional accessory for the food processing device,
wherein the cover includes a channel; and
wherein the additional unit includes a first protrusion that is slidingly releasably engageable with the channel to retain the additional unit against the cover.

18. The storage structure of claim 17, wherein the cover includes a second protrusion that is releasably engageable with a wall recess in the base unit to retain the cover against the base unit.

19. The storage structure of claim 17 or 18, wherein the cover includes a ramp leading over a wall to a first recess, and wherein the additional unit includes a tongue with a third protrusion, the third protrusion being adapted to engage the ramp and slide over the wall to engage the first recess to prevent movement of the additional unit relative to the base unit when the first protrusion has slidingly engaged the channel.

20. The storage structure of claim 19, wherein the tongue includes a through hole to allow lifting of the tongue using an angled tool.

21. The storage structure of any one of claims 17 to 20, wherein the additional unit includes a backstop to engage the base unit when the first protrusion has fully engaged the channel to prevent disengagement of the first protrusion from the channel.

22. The storage structure of any one of claims 17 to 21, wherein the additional unit includes a hook to engage a second recess in a sidewall of the base unit to prevent rotation of the additional unit relative to the base unit.

23. The storage structure according to any one of claims 1 to 22 wherein the plurality of accessories includes one or more of:
a chopping blade;
a dough blade;
an adjustable slicing disk; and
an adjustable shredding disk.

24. The storage structure according to claim 23 wherein the additional accessory is a dicing kit.

25. The storage structure according to any one of claims 1 to 24 wherein the food processing device has a lid for the bowl wherein the storage structure is configured to fit in the bowl with the lid on the bowl.

26. A storage structure for food processing device with a bowl for processing food using different accessories, the storage structure comprising:
a base unit configured to fit within the bowl, and,
formations provided on the base unit to detachably retain each of the accessories, the formations configured for individual detachment of each of the accessories without first detaching another of the accessories.

27. A storage structure for a food processing device with a bowl for processing food using different accessories, the storage structure comprising:
a base unit configured to fit within the bowl, the base unit having recesses to store the accessories, the recesses being configured for individual removal of each of the accessories without removal of another of the accessories.

28. A storage structure for a food processing device with a bowl for processing food using different accessories rotatably driven by a spindle operatively connected to a motorised base via a drive coupling within the bowl, the storage structure comprising:
a base unit configured to fit within the bowl, and the base unit having a cavity to accommodate the drive coupling when in the bowl such that the drive coupling is spaced from contact with any part of the base unit and the accessories retained by the base unit.

29. A storage structure for a food processing device with a bowl for processing food using different accessories, the storage structure comprising:
a base unit configured to fit within the bowl;
formations provided on the base unit to engage the accessories for individual removal from the storage structure without removal of another of the accessories; and,
a lift portion for manually lifting the storage structure from the bowl without user contact with any of the accessories.
